(19) United States
(12) Patent Application Publication
(10) Pub. No.: US 2026/0313307 A1
(43) Pub. Date: Oct. 8, 2026

(54) ACOUSTIC IMAGING SYSTEMS FOR VISUAL DIAGNOSIS

(71) Applicant: Fluke Corporation, Everett, WA (US)

(72) Inventors: Michael D. Stuart, Issaquah, WA (US); Max Howard Menenberg, Lynnwood, WA (US); Tako Feron, Maastricht (NL)

(21) Appl. No.: 19/490,257

(22) PCT Filed: Jun. 6, 2024
(86) PCT No.: PCT/US2024/032876

§ 371 Date: Dec. 4, 2025

Related U.S. Application Data
(60) Provisional application No. 63/506,563, filed on Jun. 6, 2023.
(60) Provisional application No. 63/607,938, filed on Dec. 8, 2023.

(51) Int. Cl. H04R 29/00; G01S 15/89; G06F 3/04842; H04R 1/22; H04R 1/40

(52) U.S. Cl. CPC H04R 29/008; G01S 15/8906; G06F 3/04842; H04R 1/222; H04R 1/406; H04R 2201/401

(57) ABSTRACT

An acoustic device and related user interface design is provided. The acoustic device enables the visual diagnosis of potential issues from a sound source in the scene, e.g., based on visually presenting one type of graphical element indicating a frequency band and another type of graphical element indicating a noise level at the sound source at the frequency band.

### BACKGROUND

An acoustic imaging device may be used to visualize sound waves, including sound waves within a frequency range audible to humans and sound waves outside of such a range, including infrasonic and ultrasonic sound waves. Such a device can create images or maps of sound fields in a given area. Such devices may be used to detect and display sound sources and their distribution in a scene. Typically, an acoustic imaging device will include an array of sensors used to detect sound waves received from various directions. The device may then convert the sound waves to electrical signals which are processed to create visual representations of the sound field.

Acoustic imaging devices have applications across different fields. They are commonly used in industrial applications, such as industrial and commercial equipment inspection and monitoring, equipment troubleshooting, pressure vessel inspection, vehicle inspection, quality testing, environmental noise monitoring, industrial noise control, architectural acoustics, product development, troubleshooting acoustic issues, and the like. They can help identify sources of noise, localize unwanted sound, assess sound propagation patterns, and optimize sound-related designs or configurations.

### SUMMARY

In general, the present disclosure relates to acoustic imaging systems for visual diagnosis of a scene. An improved user interface may be used in conjunction with acoustic imaging systems for visually diagnosing acoustic problems. Such a user interface may be presented directly on an acoustic imaging system, or remotely on another computing device communicatively connected thereto. The user interface presents a number of features simplifying the identification and display of acoustic responses captured at an acoustic imaging system. Such features may include, but are not limited to, presentation of multiple selectable, concurrent frequencies, as well as adjustability of selected frequencies, display of severity indicators based on detected acoustic information and/or changes thereto. Additionally, a variety of selectable graphical displays may be provided.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following figures:

FIG. 1 is a block diagram illustrating components of an example acoustic imaging system in which aspects of the present disclosure may be implemented.

FIG. 2 is a schematic front plan view of an acoustic imaging device on which example aspects of the present disclosure may be implemented.

FIG. 3 is a schematic rear plan view of the acoustic imaging device of FIG. 2.

FIG. 4 is a schematic plan view of an acoustic imaging sensor array that may be integrated into an acoustic imaging device, according to example aspects of the present disclosure.

FIG. 5 illustrates an acoustic imaging user interface including a field of view region and a frequency selection region that is displayable on a device such as described herein.

FIG. 6 illustrates a menu user interface displayable on a device such as described herein.

FIG. 7 illustrates a mode selection user interface displayable on a device such as described herein.

FIG. 8 is an example acoustic imaging user interface concurrently displaying a plurality of selectable frequencies on a device such as described herein.

FIG. 9 is an example of the acoustic imaging user interface of FIG. 8 with selected ones of the selectable frequencies enabled and others disabled, according to an example implementation.

FIG. 10 is an acoustic imaging user interface displaying a user-selectable frequencies on a device such as described herein.

FIG. 11 is an acoustic imaging user interface displaying a plurality of optional severity indicators within a field of view region, according to example embodiments.

FIG. 12 is an acoustic imaging user interface displaying a plurality of optional severity indicators within a field of view region, according to further example embodiments.

FIG. 13 is an acoustic imaging user interface displaying a plurality of selected frequencies and including an alert indicator associated with one of the selected frequencies, according to a further example embodiment.

FIG. 14 is an acoustic imaging user interface including a time-domain acoustic signal graph displayable alongside a field of view region, according to an example embodiment.

FIG. 15 is an acoustic imaging user interface including a frequency selection region and a time-domain acoustic signal graph displayable alongside a field of view region, according to an example embodiment.

FIG. 16 is an acoustic imaging user interface including an octave/decade log frequency chart displayable in conjunction with a field of view region, according to an example embodiment.

FIG. 17 is an acoustic imaging user interface including a log frequency response scale displayable in conjunction with a field of view region, according to an example embodiment.

FIG. 18 is an acoustic imaging user interface including a log frequency response scale displayable in conjunction with a field of view region, according to a further example embodiment.

FIG. 19 is a flowchart of a method of performing acoustic imaging on a mechanical system, in accordance with example aspects of the present disclosure.

FIG. 20 is a flowchart illustrating sub-methods of performing acoustic imaging on a mechanical system according to a selected mode of operation, in accordance with example aspects of the present disclosure.

FIG. 21 is a flowchart of a method of generating a user interface for display at a computing system in accordance with performing acoustic imaging on a mechanical system, in accordance with example aspects of the present disclosure.

FIG. 22 is a flowchart of a method of analysis of acoustic data and diagnosis of a sound source based on a first graphical indicator indicating a frequency band and a second graphical indicator indicating a noise level at the sound source at the frequency band, in accordance with example aspects of the present disclosure.

### DETAILED DESCRIPTION

Mechanical systems, such as rotating components (bearings, pulleys, and the like) may emit acoustic signals that change over time as the systems degrade. Mechanical system degradation and failure may therefore be detected through the use of acoustic imaging, for example by capturing acoustic signature data associated with a mechanical device at two or more different times, and comparing those acoustic signatures to detect changes indicative of degradation.

Previous attempts to monitor mechanical system degradation or failure using acoustic analysis typically involve monitoring a decibel reading at a single, predetermined frequency, e.g., 30 Hz. However, the acoustic response of mechanical system degradation is often not limited to or reliably detectable at a single frequency.

In at least some of the applications of acoustic imaging systems, including use in testing and/or inspection of mechanical systems (e.g., including industrial noise or mechanical system noise from rotating, reciprocating, or other movable objects), challenges exist in terms of usability. For example, in acoustically challenging or confusing environments, it may be difficult for such a device to identify the relevant acoustic signals. Furthermore, a user of such a device may have difficulty in selecting an appropriate frequency at which relevant signals might be detected. For example, a user may not know of a particular frequency at which acoustic noise representative of a particular mechanical system may be present. That user may need to perform iterative tests at different frequencies, and must use their judgment regarding which acoustic signal responses might be relevant. Or, such a user may elect to monitor a wide range of frequencies, but in acoustically challenging environments, acoustic noise may overwhelm any signals of interest that may be present, again, either within or outside of audible acoustic frequency ranges. As such, useability of existing acoustic imaging devices to effectively isolate, display, and identify potential issues or degradation in mechanical systems may be challenging. These challenges may also exist in other contexts where acoustic imaging systems are employed.

In general, the present disclosure relates to systems and methods for inspection and analysis of mechanical equipment using broad frequency acoustic imaging techniques. In some instances, an acoustic imaging device may obtain acoustic response data regarding acoustic signals emitted by mechanical equipment across a plurality of frequencies. The frequencies may be selected based on various characteristics of the mechanical equipment (e.g., its rotational speed, design type, construction materials dimensions, type of moving/rolling elements, and the like), or may be broadly selected across an acoustic frequency range. The acoustic signals may be compared to baseline acoustic signals emitted by mechanical equipment, and analyzed to determine at least one of a severity of degradation or a type of degradation. Various models or classification techniques for determining severity and/or type of degradation are provided.

In one aspect, an acoustic imaging system is disclosed. The system includes an acoustic sensor array, a camera system, a display, a processing system, and a memory. The processing system is communicatively connected to the acoustic sensor array, the camera system, and the display, and the memory is communicatively connected to the processing system. The memory stores instructions which, when executed by the processing system, cause the processing system to: capture acoustic response data regarding acoustic signals emitted by mechanical equipment across a plurality of frequencies; compare the acoustic response data to baseline acoustic response data; and based on the comparison, analyzing and classifying the acoustic response data of the mechanical equipment as to at least one of degradation severity or degradation type.

In another aspect, an acoustic imaging system is disclosed. The system includes an acoustic sensor array, a camera system, a display, a processing system, and a memory. The processing system is communicatively connected to the acoustic sensor array, the camera system, and the display, and the memory is communicatively connected to the processing system. The memory stores instructions which, when executed by the processing system, cause the processing system to: capture acoustic response data representative of acoustic signals emitted by a mechanical equipment across a plurality of frequencies; based on the acoustic response data, identify a mode of operation of the acoustic imaging system corresponding to mechanical equipment acoustic imaging from among a plurality of different modes of operation; and in accordance with the mode of operation, analyzing the acoustic response data of the mechanical equipment as to at least one of degradation severity or degradation type.

In another aspect, a method of analyzing acoustic response data is disclosed. The method includes receiving, at a computing system, acoustic response data representative of acoustic signals emitted by a mechanical equipment across a plurality of frequencies, and comparing, at the computing system, the acoustic response data to baseline acoustic response data. The method further includes determining, at the computing system, a degradation profile based on the comparison, wherein the degradation profile includes at least one of a degradation type or a degradation severity.

As briefly described above, embodiments of the present disclosure are directed to methods and systems for acoustic imaging analysis across a broad frequency spectrum. In some examples, an acoustic imaging device may obtain acoustic response data regarding acoustic signals emitted by mechanical equipment across a plurality of frequencies. The frequencies may be selected based on a rotational speed of the mechanical equipment, or may be broadly selected across an acoustic frequency range. The acoustic imaging of the present disclosure is usable to detect mechanical system degradation or failure using broad frequency acoustic signature analysis. This analysis falls into two categories: severity and categorization (e.g., the extent of degradation or failure, and the type of degradation or failure).

Regarding severity, a broad spectrum of frequencies is analyzed to determine degradation severity. In an example implementation, acoustic data is captured from known good, known degraded, and known failed mechanical systems at varying severity. A classification model may be used that generates an overall severity score. The overall severity score may be derived from a set of component values represented as a difference from a baseline “known good” mechanical system. Each component value may be weighted according to experimental determination of relative importance or extent to which it indicates likely degradation or failure. Example components may include: a comparison to baseline of a ratio of frequency components marked as periodic to overall frequency components; a comparison to baseline of the spectral power in decibels of the periodic components detected across the broad spectrum; a comparison to baseline of spectral power in a particular lower end frequency band (e.g., 15 to 20 kHz); a comparison to baseline of spectral power in a particular higher and frequency band (e.g., 35 to 40 kHz); and an inverse of a detected mechanical component rotation speed (e.g., bearing rotation speed).

To obtain many of the analysis components, a plurality of analyses on acoustic data may be performed. For example, by analyzing a broad frequency range, a periodicity analysis may be performed to determine the portions of the acoustic signal which corresponds to periodic components and the portions of the acoustic signal that are aperiodic. Ratios of periodic to aperiodic signals, and more particularly a change in the ratio of periodic to aperiodic signals within acoustic data, may be indicative of changes in state.

In further examples, more or fewer components may be used depending on their detected contribution or indication of degradation severity; the specific selection of such components, and weighting thereof, may be derived experimentally and may be supplemented using data regarding different types of mechanical systems and mechanical system failures as such data is captured.

In still further examples, an overall severity score may be defined as an integer within a range of values, with a final severity score being assigned a severity classification from among two or more severity classifications (e.g., good, pre-failure, beginning of failure, advanced failure, imminent catastrophic failure) depending on preset thresholds that are based on experimental data.

Regarding classification, experimental data has shown that different types of failures of bearings may result in different acoustic signatures across a frequency range. For example, in the case of a mechanical bearing, a good bearing will have a particular acoustic signature, while a bearing having metal flakes may have a similar acoustic signature but with greater effects of periodic components as acoustic noise is emitted at various rotational harmonics. A degreased bearing may have a slightly higher acoustic signature compared to a good bearing across low and mid frequency ranges. A rusted bearing may have a higher baseline acoustic signature at lower frequencies, as would a bearing having significant chemical etching or acid etching. Similar techniques to those used for severity classification may be implemented for failure type classification, e.g., looking at power or decibel level of acoustic data at different frequency windows, analysis of periodic versus aperiodic components, and the like.

As to both severity and categorization, the specific implementation used may vary in a few ways. For example, acoustic data may be captured via an acoustic imaging device, and transferred to a remote computing system for analysis at a later time. Such analysis may be performed and results displayed on another computing system, or returned to the acoustic imaging device for display.

Alternatively, acoustic data may be captured via an acoustic imaging device, and that data may be analyzed using particular algorithms or models implemented on that acoustic imaging device. This arrangement would allow for near real-time feedback regarding mechanical system degradation severity or type. The algorithms or models on the acoustic imaging device could be updated occasionally or periodically to improve accuracy or detect more types of degradation. Such updates may occur at the acoustic imaging device, or remotely, and returned to the acoustic imaging device for storage and use.

In a still further implementation, the analysis or modeling on the acoustic imaging device may be adaptive, and over time may adjust to accommodate new types of mechanical system failures. In this implementation, a user of the acoustic imaging device would provide annotating feedback on the device regarding known good or known faulty mechanical systems, and that information would be combined with the acoustic signature information to retrain or adapt models or equations used to determine degradation type or severity.

In accordance with the above general description and the following disclosure, it is recognized that the broad-spectrum acoustic analysis described in the present application has a variety of advantages. In particular, by analyzing acoustic response data across a wide range of frequencies, a more accurate determination of severity of degradation of mechanical equipment may be obtained, because attention is paid to frequencies that might otherwise be overlooked but which may include signatures indicative of degradation. Still further, by performing different types of acoustic analysis across broad frequency ranges, particular types of damage or degradation may be detected, for example those which are periodic versus others which are aperiodic. Furthermore, the various available analysis techniques described herein may be applied alone or in combination, thereby providing flexibility as to the amount of computational resources required, detail of degradation assessment, and the like.

In yet another aspect, a design of user interface with unique graphical elements are disclosed to enable a visual diagnosis of potential issues associated with a sound source. Given this design of user interface, the method for enabling acoustic diagnosis may include in response to an acoustic device entering into an operation mode, causing a plurality of selectable graphical indicators corresponding to respective ones of a plurality of frequency bands presented with a frequency scale on a graphical user interface; determining a noise level at a sound source at a frequency band of the plurality of frequency bands; and enabling a visual diagnosis of the sound source based on a first type of graphical indicator indicating the frequency band and a second type of graphical indicator indicating the noise level at the sound source at the frequency band being concurrently presented along the frequency scale.

The acoustic or noise level of sounds are usually measured in decibels (dB). Advantageously, by visually presenting the dB level at the sound source at a specific frequency band, the disclosed system often can help users to diagnosis the underlying problem. In this disclosure, a frequency band may be simply described as a frequency. Sometimes, a frequency band refers to a frequency plus and minus 1 kHz, e.g., 30 kHz in various figures may refers to the frequency band of 29 kHz to 31 kHz.

This method for enabling acoustic diagnosis may include other steps, such as locking the plurality of frequency bands presented with the frequency scale on the graphical user interface, or fixing spatial configurations of the plurality of frequency bands relative to the frequency scale on the graphical user interface. To enable the visual diagnosis of the sound source multiple second type of graphical indicators indicating respective noise levels at respective frequency bands of the plurality of frequency bands at the sound source may be presented. As such, acoustic information of the source, particularly dB level at the sound source at a specific frequency band may be consistently saved or analyzed in a time serial fashion, e.g., for a trend analysis based on the development of the underlying mechanical problems.

Meanwhile, this method for enabling acoustic diagnosis may include steps of floating the plurality of frequency bands presented with the frequency scale to become adjustable within a range of frequencies depicted on the frequency scale. In this way, users may reconfigure the desirable frequency bands for acoustic diagnosis.

This method may further include receiving, via the graphical user interface, a user input associated with one of the plurality of selectable graphical indicators to select or deselect the frequency band of the plurality of frequency bands; in response to the user input, causing a visual appearance change of the one of the plurality of selectable graphical indicators; or in response to the user input, causing an appearance or disappearance of the second type of graphical indicator indicating the dB level at the frequency band at the sound source.

This method may further include in response to a user selection of the operation mode, selecting the plurality of frequency bands to analyze acoustic data under the operation mode. This method may further include enabling the visual diagnosis of the sound source further based on saving the frequency band and the noise level at the frequency band as metadata of an acoustic image related to the sound source; or enabling the visual diagnosis of the sound source further based on retrieving the first information of the frequency band and the second information of the noise level at the frequency band from the metadata of the acoustic image, and analyzing the first information of the frequency band and the second information of the noise level at the frequency band in view of other acoustic images related to the sound source, such as in a time-serial view analysis; or enabling the visual diagnosis of the sound source further based on a severity indicator associated with the sound source, the severity indicator being presented on the graphical user interface together with the second type of graphical indicator indicating the noise level at the frequency band at the sound source.

An exemplary acoustic device may include a processor; and a memory storing instructions executable by the processor, wherein the instructions, when executed, cause the processor to determine a frequency band to analyze acoustic data under an operation mode of the acoustic device; analyze the acoustic data based on the frequency band; and enable a diagnosis of a sound source based on a first graphical indicator indicating the frequency band and a second graphical indicator indicating a noise level at the sound source at the frequency band being concurrently presented along a frequency scale. The disclosed system can measure the dB level at the sound source at the frequency band, e.g., based on the distance to the sound source. Advantageously, even the distance from the acoustic device to the sound source changes, the dB level at the sound source at the frequency band can be consistently measured and should remain substantially the same. In some embodiments, the second graphical indicator indicating the noise level at the sound source at the frequency band will be kept substantially stable in response to a change in a distance between the acoustic device and the sound source. Substantially stable refers to the dB level or the reading of the dB level remains unchanged or changes within a small range, e.g., plus or minus a few dB.

As briefly described above, embodiments of the present disclosure relate to an improved user interface and methods of use thereof, which may be used in conjunction with acoustic imaging systems. Such a user interface may be presented directly on an acoustic imaging system, or remotely on another computing device communicatively connected thereto. The user interface presents a number of features simplifying the identification and display of acoustic responses captured at an acoustic imaging system.

In example embodiments, the user interface may include a field of view region and one or more other regions displaying control features associated with display of captured acoustic data. For example, a frequency selection region may be presented. The frequency selection region may include a plurality of predefined or customized frequencies that are concurrently displayed. A user may manually select the frequencies presented within the frequency selection region to enable or disable display of captured acoustic signals at those frequencies. The user may also manually adjust the frequencies, for example to move one or more frequencies within a frequency range displayed in the frequency selection region. An overlay illustrating detected acoustic signals, presented within a field of view region within the user interface, may be updated based on the selected or enabled frequencies.

In example aspects, the user interface may include one or more severity indicators presented graphically within either the field of view region or the frequency selection region, or some combination thereof. For example, user interface elements may be color-coded to indicate severity of, or likelihood of, failure of mechanical components based on historical data or based on a current acoustic signal level, or some combination thereof. Additionally or alternatively, one or more text-based indicators may be used to communicate severity, for example using predefined severity levels (e.g., acceptable, low risk, medium risk, high risk, and the like) or using scored likelihood of failure (e.g., a 0 to 100 scale). Still further, other graphical elements may be used to convey severity of performance degradation, for example using traffic signals, iconography, and the like.

In further example aspects, the user interface may be adjustable to display one or more other types of graphs or charts, either to illustrate six acoustic signal response or as control mechanisms. For example, a time domain acoustic signal graph, an octave decade frequency log chart, a log frequency response scale, or some combination of such charts alongside the frequency selection region may be used.

In some implementations, the user interface may be presented on a display, such as a display of an acoustic imaging device. In some particular examples, the display may be a touchscreen display. In other examples, the display may be presented on a device communicatively connected to the acoustic imaging device. In such instances, the device may be a personal computing system (e.g., desktop or laptop, or tablet device) or mobile device, and may include a touchscreen display or other types of display and user input devices.

Overall, and referring to the example user interfaces and methods of interaction with such user interfaces as described herein, it is apparent that the user interface features described herein provide significant usability advantages for individual users interacting with acoustic imaging systems. In particular, the user interface features described herein improve the ability of a technician or individual conducting inspections of target objects through the use of broad-frequency acoustic imaging technology. Such a system that allows for multi-frequency analysis, both individually and concurrently, provides for faster and more accurate diagnosis of potential degradation and/or failure issues, and provides greater value, efficiency, speed, and confidence to the user. This, in turn improves an organization's ability to successfully inspect and maintain mechanical components and equipment, enabling increased uptime, better technician safety, less-intensive training, better technician decision-making and communication, and decreased overall costs of operation.

In one aspect, a computing device is provided. The computing device includes a display screen, a processor, and a memory storing instructions executable by the processor. The instructions, when executed, cause the computing device to display, on the display screen, a user interface including a field of view region and a frequency selection region. The frequency selection region displays a frequency scale and includes a plurality of selectable frequency indicators concurrently displayable thereon. The plurality of selectable frequency indicators include at least a first selectable frequency indicator and a second selectable frequency indicator, the first and second selectable frequency indicators being selectable independently of one another and indicating different frequencies on the frequency scale. The field of view region displays an image of a field of view including an overlay of a detected acoustic signal strength, the overlay of the detected acoustic signal strength being based, at least in part, on selected ones of the plurality of selectable frequency indicators identified in the frequency selection region.

In one aspect, an acoustic imaging device includes an acoustic sensor array, a camera system, a touch-screen display, and a processing system communicatively connected to the acoustic sensor array, the camera system, and the touch-screen display. The acoustic imaging device further includes a memory communicatively connected to the processing system, the memory storing instructions which, when executed by the processing system, cause the processing system to generate a graphical user interface displayable on the touch-screen display. The graphical user interface includes a frequency selection region displaying a frequency scale and including a plurality of selectable frequency indicators concurrently displayable thereon, the plurality of selectable frequency indicators including at least a first selectable frequency indicator and a second selectable frequency indicator, the first and second selectable frequency indicators being selectable independently of one another and indicating different frequencies on the frequency scale. The graphical user interface also includes a field of view region displaying an image of a field of view of the camera system including an overlay of a detected acoustic signal strength obtained from the acoustic sensor array, the overlay of the detected acoustic signal strength being based, at least in part, on selected ones of the plurality of selectable frequency indicators identified in the frequency selection region.

In one aspect, a method of performing acoustic imaging of a mechanical system is provided. The method includes receiving a selection of a mechanical device acoustic imaging mode at a display screen associated with an acoustic imaging device, and receiving a selection of an option from among a plurality of options displayed on the display screen in response to selection of the mechanical device acoustic imaging mode, where the option is selected from among a single frequency option, a multifrequency option, and a customizable frequency option. The method includes, in response to receiving selection of the multifrequency option, displaying a user interface on the display screen, the user interface including a frequency selection region and a field of view region. The frequency selection region displays a frequency scale and including a plurality of selectable frequency indicators concurrently displayable thereon, the plurality of selectable frequency indicators including a plurality of predefined frequencies, each of the predefined frequencies being selectable via the display to be enabled or disabled within the frequency selection region. The field of view region displaying an image of a field of view represented in image data including an overlay of a detected acoustic signal strength obtained from an acoustic sensor data. The method also includes receiving selection of one or more of the plurality of selectable frequency indicators to cause a subset of the predefined frequencies to be enabled, wherein the overlay of the detected acoustic signal strength is based, at least in part, on the enabled ones of the plurality of selectable frequency indicators.

In particular examples, inclusion of a plurality of preset, selectable, or deactivatable frequencies that are selected at frequencies where mechanical devices and systems typically exhibit failure behaviors allows a user to more quickly identify the frequencies at which responses are received from a particular mechanical component, as well as to quickly identify and compare acoustic response from that component across multiple assessments. Additionally, by defining thresholds for acoustic signal levels, or by comparing to historical acoustic signal levels, severity indicators may more easily identify to a user the likelihood or possibility of component failure or degradation without requiring significant user training to identify such issues. The various types of graphical displays may also better illustrate the signature of acoustic signals emitted by a mechanical system; the amplitude of such signals at various periodicities, as reflected in the frequency response, may visually depict performance (or performance degradation) of such a system. Other advantages are apparent as well, and are as reflected in the following description.

### I. Operating Environment and Example Acoustic Imaging Systems

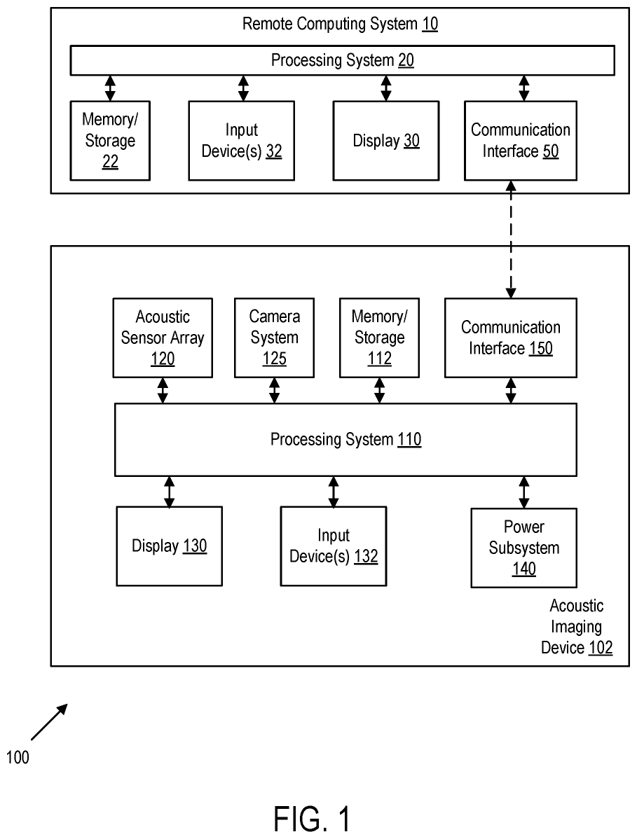

Referring first to FIGS. 1-4, example acoustic imaging systems in which the user interfaces and methods of use and operation may be performed are described. The systems described herein should be considered exemplary, in that the user interfaces may be presented on a wide variety of types of systems and in various contexts, as is apparent from the details of those interfaces themselves.

Referring initially to FIG. 1, an example acoustic imaging system 100 is depicted. The acoustic imaging system may include, in the example shown, an acoustic imaging device 102, optionally communicatively connected to one or more remote computing systems, such as remote system 10.

The acoustic imaging device 102 may be, in various embodiments, a handheld device, a robotic or self-propelled device (e.g., either ground-based or airborne, as in the case of a drone), or a stationary device positioned to receive acoustic signals. In general terms, an acoustic imaging device, also referred to herein as an acoustic camera or acoustic imaging system, visualize sound waves and create images or maps of sound fields in a given area. It is designed to detect and display sound sources and their distribution, for example in real time. In the example shown, the acoustic imaging device 102 includes a processing system 110 communicatively connected to a memory 112, as well as to an acoustic sensor array 120, a camera system 125, a display 130, input devices 132, a power subsystem 140, and a communication interface 150.

In the example shown the processing system 110 can include one or more programmable or special-purpose execution circuits capable of executing computing instructions. The memory 112 may be volatile or nonvolatile memory, such as read-only memory (“ROM”), random access memory (“RAM”), EEPROM, flash memory, or other memory technology. Those of ordinary skill in the art and others will recognize that memory 112 typically stores data or program modules that are immediately accessible to or currently being operated on by the processing system 110. In this regard, the processing system 110, including one or more processors, may serve as a computational center of the acoustic imaging device 102 by supporting the execution of instructions.

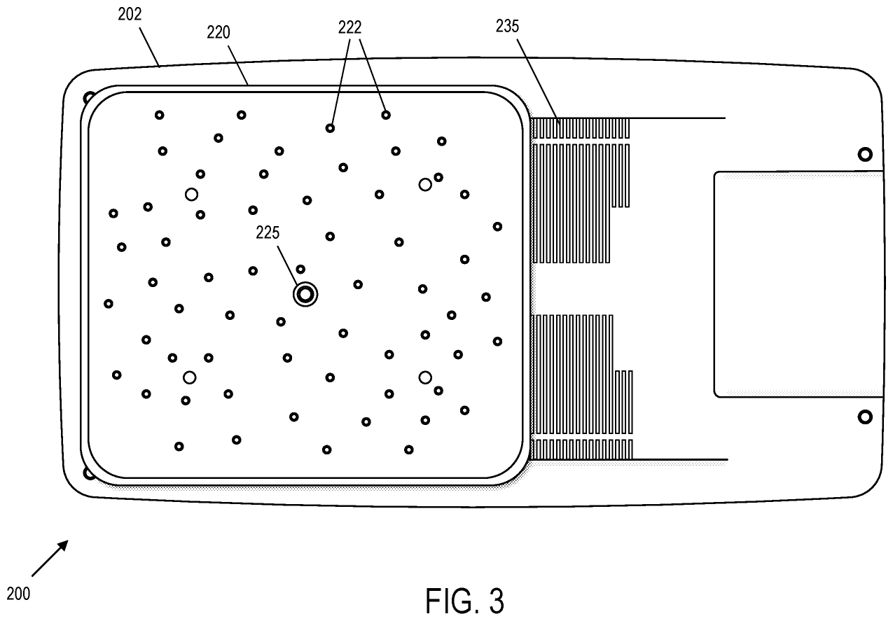

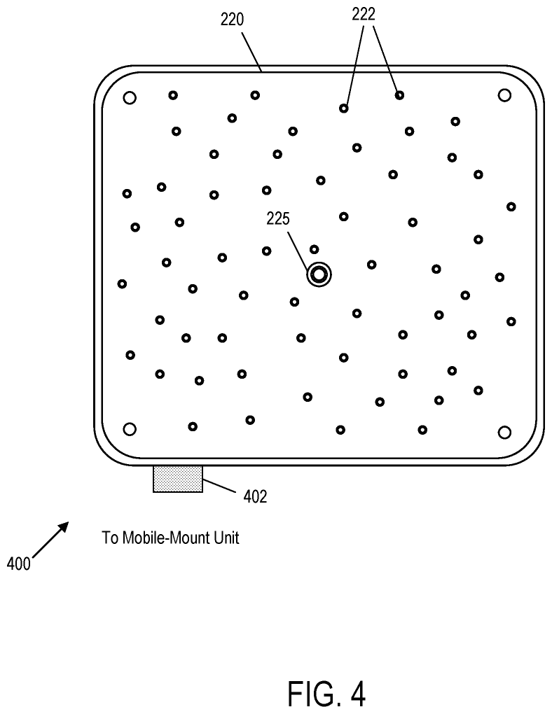

The acoustic sensor array 120 may include a plurality of spaced-apart acoustic sensors positioned to determine, based on the time and phase of receipt of acoustic signals, the direction, distance, and magnitude of signals emitted from an acoustic source. For example, in some implementations, the acoustic sensor array 120 may include up to 64 or more acoustic sensors spaced apart from each other, and configured to detect acoustic signals in a frequency band of between 2 kHz and 90 kHz at up to, or exceeding, 70 meters. Other frequency bands may be used as well, including those below 2 kHz and up to or exceeding about 100 kHz. Each sensor within the array is responsible for detecting and measuring the acoustic signals at a specific location. Each acoustic sensor within the array may be positioned in a specific spatial configuration, typically in a planar arrangement. The acoustic sensor array may include various signal amplifiers and/or analog to digital converter circuits, as well as a signal processing unit useable to extract relevant data from the sensor array. In some examples, the acoustic sensor array may include such a signal processing unit, while in other examples, the processing system 110 may perform signal processing. An example of such an acoustic sensor array 120 is depicted in FIGS. 3-4, below.

The camera system 125 is positioned to capture an imaging field of view relative to the acoustic imaging device 102. The camera system captures image data, typically in a same direction of orientation as the acoustic sensor array 120, thereby allowing for display of image data with an overlay of acoustic signal data as described herein. In examples, the camera system 125 may be a digital still image camera, a video camera, or may include a plurality of camera devices. In example implementations, the camera system may include a digital camera configured to capture images at greater than 1 megapixel in image quality, and may have digital and/or optical zoom capabilities.

The display 130 may be any of a variety of display devices adapted for display of the image and acoustic information captured using the acoustic sensor array 120 and the camera system 125. In example implementations, the display 130 may be an LCD display and may be capable of receiving user input. In some examples, the display 130 is a touchscreen display, such as a capacitive touchscreen display.

The input devices 132 may include various additional input buttons or switches that are provided on the acoustic imaging device 102 beyond the touchscreen display. For example, in some instances, the input devices 132 may include a power button, an image capture button useable for image capture or to start/stop video capture, and the like.

The power subsystem 140 may include one or more power sources, such as a battery capable of providing electrical energy to the other components of the acoustic imaging device 102. In examples, the power subsystem 140 may include a rechargeable battery, such as a lithium-ion battery. Other battery types or power sources may be provided as well, such as a wired power connection.

The communication interface 150 may include one or more components for communicating with other devices, for example via a direct wired connection or over a network. Embodiments of the present disclosure may access basic services that utilize the communication interface 150 to perform communications using common network protocols. The communication interface 150 may correspond to a general purpose wired connection, such as a USB, Firewire, or analogous data connection, and/or may also include a wireless network interface configured to communicate via one or more wireless communication protocols, such as WiFi, 2G, 3G, 4G, 5G, LTE, WiMAX, Bluetooth, or the like.

In the example shown, the acoustic imaging device 102 is communicatively connectable, via the communication interface 150, to remote system 10. The remote system 10 includes a processing system 20, memory 22, display 30, input devices 32, and a communication interface 50, by way of example.

The remote system 10 may be implemented as a computing system, such as a desktop, laptop, or handheld portable computing system (e.g., a tablet, cellular telephone, or other mobile device). The processing system 20 and memory 22 are analogous to those described above as included in the acoustic imaging device 102. Display 30 may be an LED, LCD, OLED, or other type of display, and may be implemented as a touchscreen or non-touchscreen display as well. The display 30 may be configured to present the various user interfaces described herein when image and acoustic data are received at the remote system 10 from the acoustic imaging device 102. Input devices 32 generally may include one or more buttons, touch inputs, and the like, which are dependent on the form factor of the remote system 10. The input devices 32 may include, for example, a keyboard, mouse, stylus, and the like.

The communication interface 50 is configured to provide wired and/or wireless communication with other devices, and can include, for example, a complementary connection to the communication interface 150 above. Via the communication interfaces 50, 150, the acoustic imaging device 102 and remote system 10 may exchange data captured via the acoustic sensor array 120 and camera system, and instructions from remote system 10, to allow for, e.g., local or remote storage of current and historical acoustic test data including acoustic data and image data, as well as remote control of the acoustic imaging device 102. The storage of current and historical acoustic test data may include storage of location information, acoustic signal levels, image data, test settings, and the like, and may be used, either alone or in combination with other test data, to determine or estimate a probability of degradation or failure of a target object that is the subject of acoustic imaging.

In accordance with aspects of the present disclosure, it is noted that some or all of the features of the acoustic imaging device 102 and/or remote system 10 may or may not be present in all implementations, and that such devices may include other functionalities and features (e.g., remote control features, mobility features, and the like) not described here. Generally speaking, the acoustic imaging device 102 and remote system 10 may be configured with a display capable of depicting the user interfaces described herein, either in real-time as part of control of the acoustic imaging device 102 or based on stored data and/or data transmitted from the acoustic imaging device 102 to the remote system 10. It is also noted that the acoustic imaging device and remote system may be referred to as a first computing device and/or a second computing device in aspects of the present disclosure and claims appended hereto.

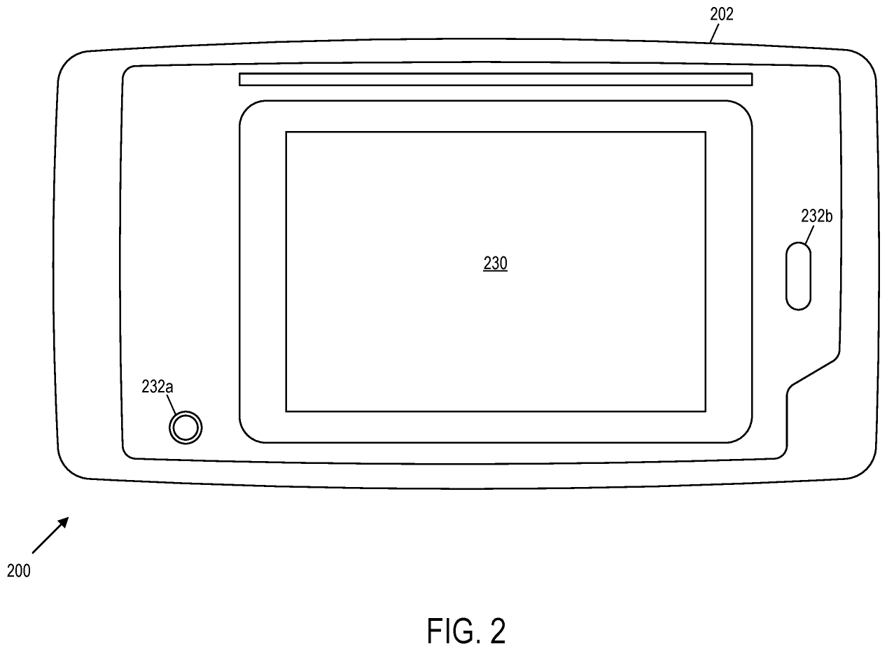

FIGS. 2-3 are schematic front and rear views of an acoustic imaging device 200 on which example aspects of the present disclosure may be implemented. The acoustic imaging device 200 is an example of a physical implementation of the acoustic imaging device 102 of FIG. 1, for example when implemented as a manual handheld unit.

As seen in FIG. 2, the acoustic imaging device 200 includes a touchscreen display 230 positioned within a housing 202. The touchscreen display may be controlled via manual touch operations on user interface elements, such as those described below. A power button 232a activates the acoustic imaging device 200, and a capture button 232b initiates capture of concurrent image and acoustic data, either in still/instantaneous capture mode or a video/streaming mode.

On a rear side of the housing 202, an acoustic array 220 is mounted to the housing 202. The acoustic array 220 includes a plurality of acoustic sensors 222, for example miniaturized microphones, which are spaced apart from one another along two dimensions on the acoustic array 220. The plurality of acoustic sensors 222 determine, collectively, a direction and signal strength of an acoustic signal. The acoustic sensors 222 may also be used, in some cases, to determine a distance of the acoustic signal from the acoustic imaging device 200. This can be performed, for example, either alone or in combination with image data obtained by a camera 225. The camera 225 is positioned to be oriented in a direction normal to the plane defined by the plurality of acoustic sensors, such that the camera 225 captures a field of view in a direction from which acoustic signals may be sensed. In the example shown, the camera 225 is positioned in the center of the acoustic array 220; however, in other implementations, the camera may be located in other locations. In the example shown, a speaker/vent system 235 is also provided on the rear side of the housing 202, provides air communication into the housing 202, and allows emission of audible feedback, e.g., from a speaker.

In use, the acoustic imaging device 200 may be positioned or oriented toward an object of interest, for example such that the acoustic array 220 and the camera 225 are aimed at an object. A user may press a capture button 232b to initiate an acoustic sampling process, for example to capture image data and acoustic signals, and again to terminate capture (e.g. in video or streaming mode). Captured data may be displayed on the display 230, for example for manipulation and viewing.

FIG. 4 is a schematic plan view of an acoustic imaging sensor array 400 that may be integrated into an acoustic imaging device, according to example aspects of the present disclosure. The acoustic imaging sensor array 400 includes acoustic array 220, including acoustic sensors 222 as described above. The acoustic imaging sensor array 400 further includes a camera 225, also described above. In this example, a connector 402 allows for connection of the acoustic imaging sensor array 400 other electronic systems, for example as may be incorporated into a static mounted sensor system or onto a mobile device, such as a land-based mobile unit, airborne drone, or the like.

As noted above, an acoustic imaging device 200 or acoustic imaging sensor array 400 may be usable in a variety of applications. For example, acoustic signals may be emitted by pneumatic devices (e.g. detection of air leaks and the like), electrical devices (e.g. detection of sparks, periodic noise generated by electrical signals, and the like) and in some embodiments as described herein mechanical devices (e.g., bearings, rollers, or various other reciprocating or moving systems, such as motors, conveyors, gears and gearboxes, couplings fans, compressors, and mechanical robots.). In the particular case of mechanical devices, detection of acoustic signals emitted by a particular mechanical device may allow a user to determine the likely operational state that mechanical device. For example, operational mechanical devices may have a particular acoustic signature, while mechanical devices in varying states of operational wear or failure may exhibit other characteristics. For example, failing bearings or rotors may emit acoustic noise at higher frequencies that may be difficult to hear audibly, but which may be detected via the acoustic array 220. Other mechanical devices may exhibit wear or failure modes via other types of acoustic output. Additionally, electrical or pneumatic systems may also indicate the presence of failure by way of acoustic signals at various frequencies. Each of these acoustic characteristics may be difficult for even a skilled and highly trained individual user of an acoustic imaging system to readily identify using the devices and systems currently available, in which acoustic response at an individual frequency is analyzed.

### II. Acoustic Imaging User Interfaces

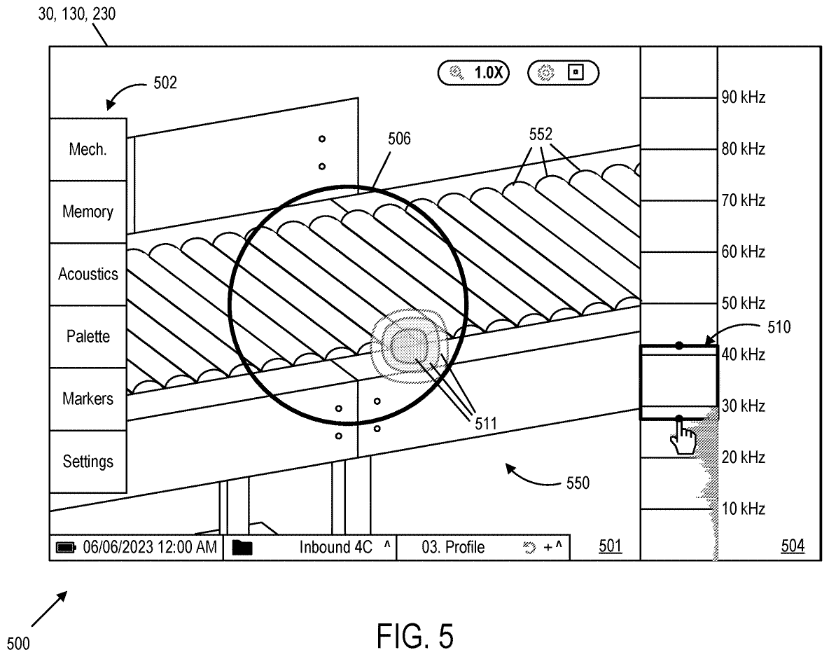

Referring now to FIGS. 5-18, various user interfaces that may be presented on a display associated with an acoustic imaging system are described and illustrated. The user interfaces may be presented on a display of an acoustic imaging device, such as displays 130, 230, or on a display of a remote system that receives image and acoustic data from such a device, such as display 30 of remote system 10. The user interfaces described herein may be used either for control of an acoustic imaging device, or for analysis of captured data, for example to assess an acoustic response of a system being analyzed either in real time or after image capture takes place.

FIG. 5 illustrates an acoustic imaging user interface 500, including a field of view region 501 and a frequency selection region 504. The acoustic imaging user interface 500 may be presentable on a display, such as displays 30, 130, 230. The field of view region 501 displays image data associated with an image captured by a camera system of an acoustic imaging device, as well as an overlay of acoustic signals within a frequency range selected by a user within the frequency selection region 504. In particular, the field of view region 501 includes a focus indicator 506. The focus indicator 506 illustrates an area in which an acoustic imaging device is configured to focus image data and in which acoustic sensor data is likely most accurate (e.g., by being centered within the acoustic sensor array).

In the example shown, the field of view region 501 depicts a scene including a mechanical device 550, such as a conveyor belt having a plurality of rollers 552 each associated with bearing is allowing for rotation of the roller. A user will select, using a manipulable frequency selection slider 510, a range of frequencies along a frequency range. The range of frequencies identified by the slider 510 correspond to the frequencies for which an overlay within the field of view region 501 is generated. In the example as shown, overlay 511 depicts acoustic response at a plurality of different threshold levels (in the example shown, at three different threshold levels, indicating comparative intensity of acoustic signal response).

While the user interface 500 allows a user to see acoustic response within the field of view region 501, it provides limited capabilities for the user to identify all potential frequencies of signals emitted by the mechanical system. Because mechanical systems may have failure modes in which different frequency acoustic signal are generated, it is advantageous to provide additional ability to a user to select multiple frequencies for analysis. Within the user interface 500, a user might be able to create a wide frequency window using the slider 510 in an attempt to view acoustic response across a wide range of frequencies. However, the user would be required to either set a relatively wide frequency range or to move the slider 510 such that it would only display different, narrowed ranges at different times without displaying an aggregate of the acoustic response from the particular mechanical component. If a relatively wide frequency range is set, it is likely that acoustic noise would interfere with display of the acoustic signals emitted by the mechanical component. As such, other graphical displays and modes of operation are desired.

Still further, single-frequency analysis and/or comparison to previous test or analysis data can be subject to significant errors due to inherent equipment design, unique degradation properties, environmental factors, and varying sensitivity of acoustic sensors. Measurements of the total dynamic range of sound (infrasound, audible sound, and ultrasound) over a wide frequency range can be much more representative of the condition of the target object (e.g., a bearing or mechanical device) for purposes of comparison. Such analysis can help to avoid the pitfalls of single-frequency methods.

In a particular implementation, an operation selection menu 502 is displayed as a menu bar, and presents a plurality of operating characteristics as options for selection. In the example shown, the operation selection menu 502 allows for control of a mode (e.g., a mechanical mode in this case), memory management of on-device memory, acoustic signal settings, as well as annotation settings including a color palette usable for the acoustic overlay, markers that may be applied as part of the acoustic overlay and the like.

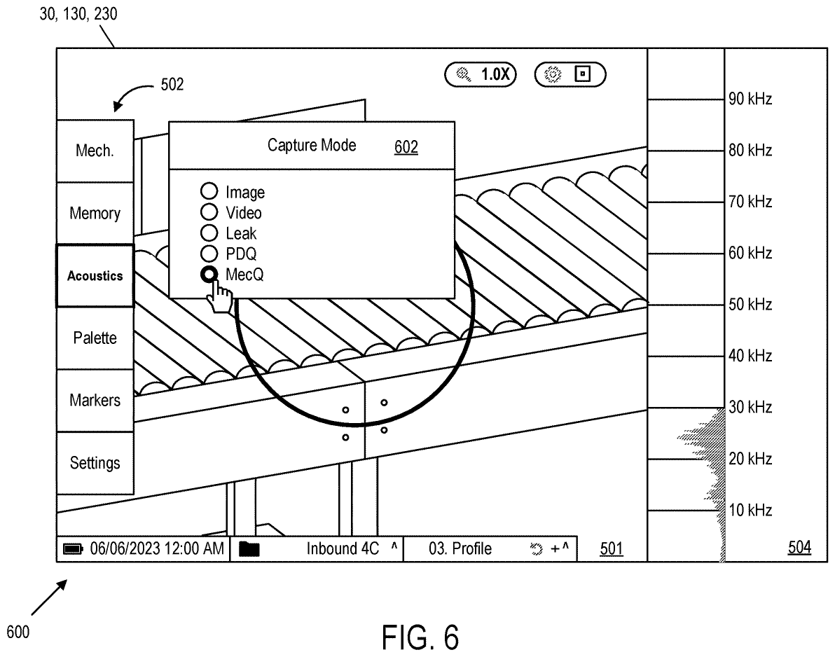

FIG. 6 illustrates a menu user interface 600 displayable on a device such as described herein. The menu user interface 600 may be presented on a display, such as displays 30, 130, 230 as described above. The menu user interface 600 may be presented in response to selection of the acoustic imaging option within the operation selection menu 502 described previously. In this example, a menu 602 presents a plurality of capture modes. A capture mode that is a subject of the present disclosure corresponds to a mechanical device acoustic response capture mode, abbreviated as a “MecQ” mode. Other modes, such as image capture mode, video capture mode, leak capture mode, pulse capture (“PDQ”) mode, and the like, are available as well.

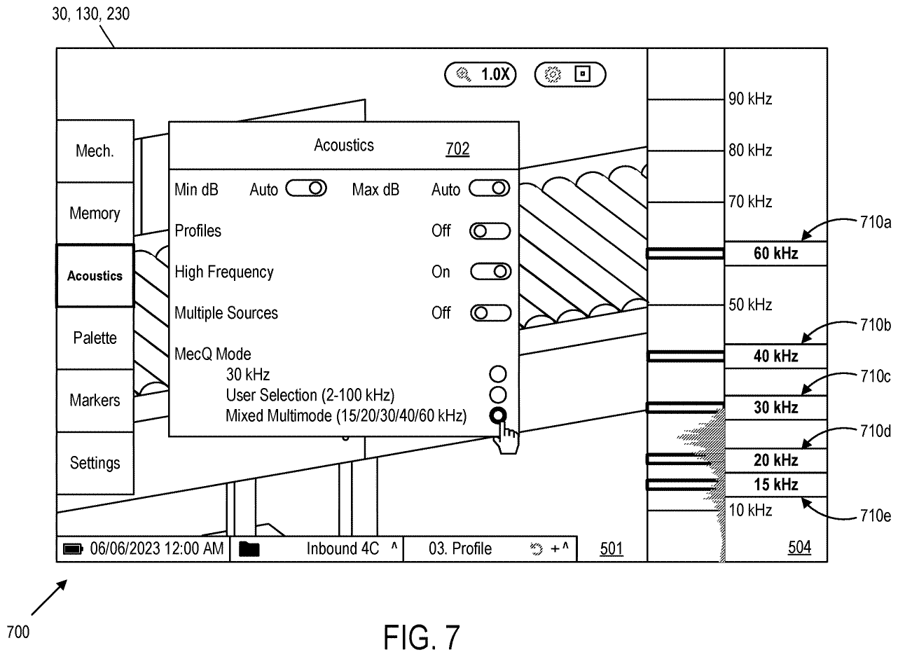

FIG. 7 illustrates a mode settings selection user interface 700 displayable on a device such as described herein. The mode settings selection user interface 700 includes and acoustic settings menu sub screen 702. The acoustic settings menu sub screen 702 presents a plurality of acoustic settings selectable by a user in response to selection of the mechanical device acoustic response capture mode in the menu user interface 600 of FIG. 6. In this example, a user may select to manually or automatically set a minimum decibel level and maximum decibel level considered within the graphical display, as well as enable one or more known acoustic profiles. Additionally, the user may enable detection of high frequency events and multiple acoustic sources.

In addition, in the example shown, the acoustic settings menu sub screen 702 allows a user to select a particular mode of operation within the mechanical device acoustic response capture mode. The modes of operation may include a fixed 30 kHz mode, a user selectable frequency mode (between 2 and 100 kHz), and a mixed multi-mode option, in which a set of discrete, preselected frequencies and/or frequency sub-ranges (either of which referred to herein as discrete frequencies for simplicity) are individually enabled or disabled as part of the overlaid display of acoustic response.

In the example of the mode settings selection user interface 700 provided, with the mixed multi-mode option selected a plurality of selectable, discrete frequency indicators 710a-e (referred to collectively as frequency indicators 710) are displayed. The selectable frequency indicators 710a-e are each associated with a different, discrete frequency, or different, discrete range of frequencies different from one another, and which may be preselected in accordance with the mechanical device acoustic response capture mode. In particular, in the example shown, discrete frequencies of 15 kHz, 20 kHz, 30 kHz, 40 kHz, and 60 kHz are presented in association with frequency indicators 710a-e, respectively. In alternative implementations, other numbers of frequency indicators can be displayed, and other frequencies used either by default or as preselected by a user. Further examples of use of such frequency indicators, and additional examples of the mode options, are provided in further detail below.

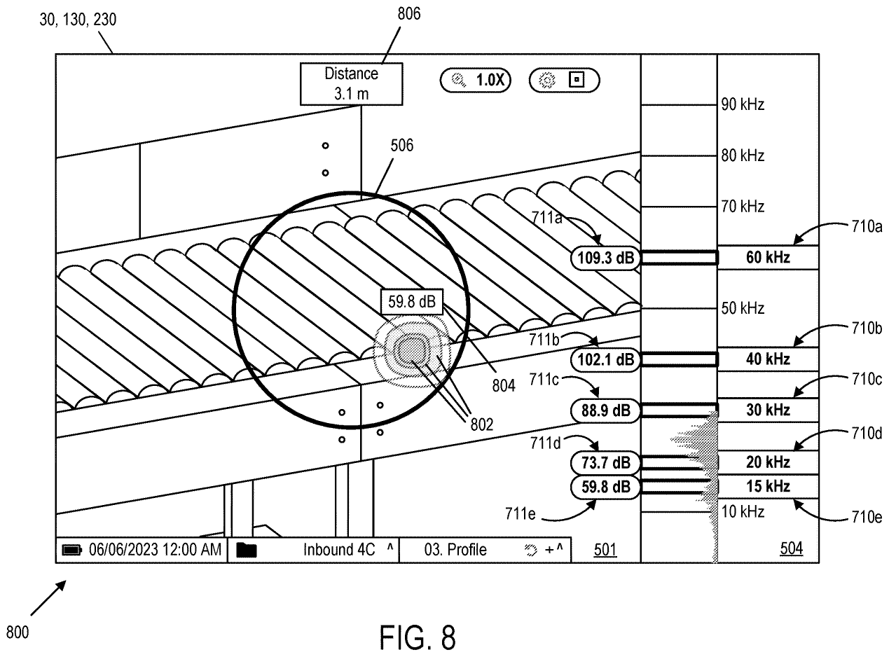

FIG. 8 is an example acoustic imaging user interface 800 concurrently displaying a plurality of selectable frequencies on a device such as described herein. The acoustic imaging user interface 800 may be displayed in response to selection of the mixed multi-mode option described as presented within the acoustic settings menu sub screen 702 of FIG. 7. In the example shown, the plurality of frequency indicators 710a-e are again displayed. In this case, each frequency indicator is associated with an acoustic signal level indicator 711a-e, respectively. Each acoustic signal level indicator 711 displays an acoustic signal level for captured signals at that particular frequency. Accordingly, a user may readily determine the frequencies at which significant acoustic signal components contribute to an overall signal strength reflected in an acoustic signal overlay. In the example shown, the acoustic signal level indicators 711 are presented proximate to the corresponding ones of the frequency indicators 710, e.g., on opposite sides of the frequency scale bar. The acoustic signal level indicator 711 may be positioned, in whole or in part, within the field of view region 501 in the manner depicted in FIG. 8. In alternative embodiments, the acoustic signal level indicators 711 may be positioned in whole or in part within the frequency selection region 504.

In the example shown, within the field of view region 501 of acoustic imaging user interface 800, an overlay 802 is presented. The overlay 802 may be presented as having a plurality of colors or regions representing relative intensity or strength of the acoustic signal, as determined by an acoustic sensor array described previously. In particular, the overlay 802 may reflect a general strength or intensity of acoustic signals within the selected frequencies from among those identified by the frequency indicators 710a-e.

In addition to the overlay, a text value 804 may be displayed in proximity to the overlay within the focus indicator 506. The text value 804 may present an overall acoustic reading display representing an overall signal strength or a maximum signal strength of the aggregate acoustic signals represented by the overlay 802. In some embodiments, the overall signal strength refers to the dB level at the sensors of acoustic device. Therefore, when the distance from the acoustic device to the sound source changes, text value 804 may be updated according to the distance, as the dB level decreases for an increased distance.

The text value 804 may also be toggled to individually depict signal strength associated with each of the selected frequencies that are selected for inclusion in user analysis. Such a toggling may be performed in various orders: e.g., in order of increasing or decreasing frequency, in order of increasing or decreasing signal strength (by dB level), or by sound source (where multiple sound sources fall within the focus indicator area).

Additionally, in the example shown, a distance indicator 806 may be presented. The distance indicator 806 illustrates a distance between the acoustic imaging device that was used to capture the depicted image and overlay and the device within the focus indicator 506. In the example shown, a distance of 3.1 m is depicted, illustrating that such a distance is calculated between the acoustic imaging device and a target object, e.g., the roller emitting acoustic signals that is presented on the conveyor belt arrangement. The distance depicted in the distance indicator 806 may be a manually entered distance, or may be a distance calculated based on use of an integrated optical measuring device included as part of the camera system of an acoustic imaging tool, or using acoustic signals themselves. Details regarding capture of or entry of distances to target are described in further details in U.S. Pre-Grant Publication No. 2022/0170780, entitled “Portable Acoustic Imaging Tool with Scanning and Analysis Capability”, the disclosure of which is hereby incorporated by reference in its entirety.

In example implementations, the text value 804 of signal strength may be a signal strength as detected at an acoustic sensor array, such as provided by acoustic imaging device 102 described above. In other implementations, the text value 804 may represent signal strength of a signal as emitted from a target object. This may be an extrapolated or calculated value based on an inverse square relationship between the signal strength detected at the acoustic sensor array and the automatically-determined or manually-entered distance value. The text value 804 may also be toggled between the signal strength at the target object and a signal strength as received at the acoustic imaging device, or both values may be displayed, in some examples. Such a toggle feature may be provided, e.g., either for previously captured or real-time displayed data.

Diagnostic analysis in the field of reliability and maintenance of equipment can be accomplished in a variety of ways depending upon the circumstances. For example, diagnostic analysis may be performed using data and information that is collected in-situ at a single point in time. In other cases, diagnostic analysis may be performed using time-based monitoring and trending of equipment at multiple points in time. Both types of analysis are valuable to a reliability and maintenance practitioner.

Acoustic imaging tools and systems, perhaps greater than some other tools, are particularly subject to challenges posed by poorly collected data. Poorly collected data due to inconsistent setting of parameters and inconsistent correlation of important data points can result in incorrect analysis and misdiagnosis of equipment performance. Parameters that need to be addressed and consistently managed may include frequency level, frequency span, distance to target, and other parameters. It is common for parameter management to be done manually by users of acoustic imaging devices, and human-induced errors are frequent, as even a change in one parameter can change the measured and calculated data.

Furthermore, most acoustic imaging systems are currently set up to collect data and metadata on one frequency at a time or one frequency band (span/level) at a time. While this can be useful in many instances for providing a snapshot of the sound (including ultrasound) at that particular frequency band, it does not always provide diagnostic utility and direction in itself. The ability to compare a decibel level measurement at one frequency consistently with a decibel level measurement at a different frequency or multiple different frequencies, at the same time, provides significantly more information from which an in-situ analysis can be performed.

For example, in some mechanical inspection applications, there is a correlation between decibel levels at certain frequencies and the severity of performance degradation of the mechanical system, where the progression of deterioration follows a lowering shift in frequency of the sound and ultrasound emanating from the mechanical system. This observation supports the need to visualize as well as save data at multiple frequencies across a range. Similarly, the ability to compare a decibel level at a selected frequency at one point in time to decibel levels at that same frequency level at multiple points in time provides added diagnostic value, and potentially predictive value, to the user through time-based trending of equipment performance. Consistency in respect to such measurements and analysis is critical for proper evaluation of trending to take place. If the data collected at a frequency level and span from one time is different than the frequency level and span at another time, the variability may cause errors that render the trending analysis unacceptable, at least beyond a certain point. Furthermore, being able to consistently evaluate trends at multiple frequencies (or frequency bands) over time can provide a multiplied value of both of the above situations, increasing the ability to perform condition-based analysis to yet another level of performance. In addition, for both of the above situations, analysis and diagnostics based upon the collected data could be performed automatically, semi-automatically, or manually. In automatic and semi-automatic performance, the device collecting the data could provide immediate graphical notifications of the in-situ acoustic analysis and diagnostics and/or provide for graphical representation of acoustic trending analysis and diagnostics.

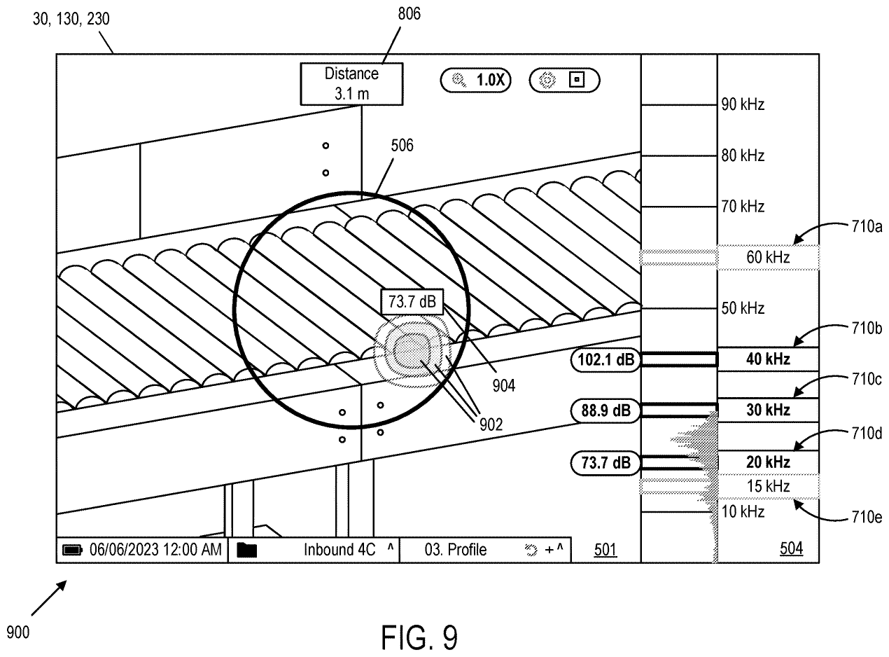

FIG. 9 illustrates a further example of an acoustic imaging user interface 900, according to an example implementation. The acoustic imaging user interface 900 generally corresponds to the user interface 800 of FIG. 8, but illustrates that by selection of individual ones of the frequency indicators 710a-e, those frequency indicators may be enabled or disabled, resulting in a change in the overlay 902 illustrating the intensity of acoustic signals detected. Users may simply select or deselect a frequency indicator by touching the indicator on the screen, maneuvering a physical user interface element (e.g., a functional button), or other means of user input to the acoustic device.

In the example shown, frequency indicators 710a, 710e were selected to be disabled, while frequency indicators 710b-d were selected to be enabled. Accordingly, the overlay 902 as well as the text value 904 indicating overall signal strength or maximum signal strength are updated to reflect only those frequencies that are currently enabled. Accordingly, a user may quickly select or deselect particular frequencies to identify component frequencies that are greatest contributors to overall acoustic signal strength of detected acoustic signals. This allows the user to isolate frequencies of interest quickly, and easily exclude those on which significant interference is experienced.

It is noted that, in example implementations, the acoustic signal level indicators 711 and frequency indicators 710 may vary in number, and that the frequency indicators 710 may only be selectively displayed when the corresponding acoustic signal level indicator is selected and active. Furthermore, the specific frequency levels at which the frequency indicators 710 are placed may vary based on preset user settings, based on historical usage patterns, and the like.

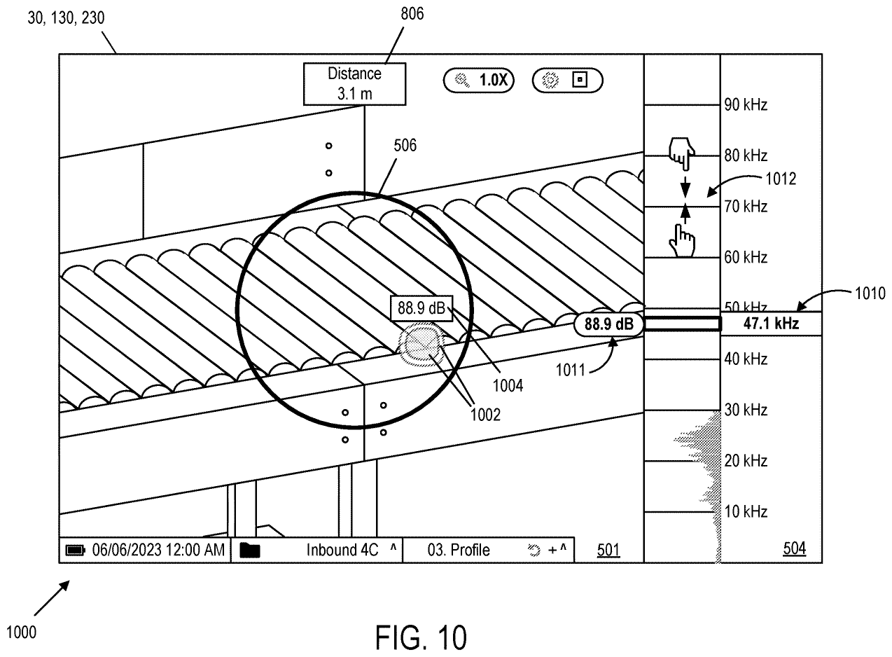

FIG. 10 illustrates a further example of an acoustic imaging user interface 1000. In this example, a user-selectable frequency is selected for display. In particular, a frequency indicator 1010 may be manually selected by entering a frequency value on the touch screen display or by way of user input on a device, such as remote system 10 or acoustic imaging device 102 as described previously. The frequency indicator 1010 may be manually manipulable, for example via a touch screen display, by sliding the selected indicator along the frequency range presented within the frequency selection region 504. As the frequency indicator 1010 is moved, the acoustic signal level indicator 1011 may be updated with the acoustic signal level at the selected frequency. Additionally, the overlay 1002 may be updated to reflect acoustic signal strength and position associated with the selected frequency. The text value 1004 may also be updated to reflect the acoustic signal strength at the selected frequency. It is noted that in the acoustic imaging user interface 1000, a single frequency indicator 1010 is depicted. However, as is apparent from the present disclosure, two or more such manipulable frequency indicators may be included within the user interface. Each of the frequency indicators may be independently movable along the frequency range presented within the frequency selection region 504, with the overall signal strength reflected in the overlay 1002 and the text value 1004 updated accordingly. When a frequency indicator become movable, the user may then reconfigure suitable frequency bands to visually diagnose acoustic problems.

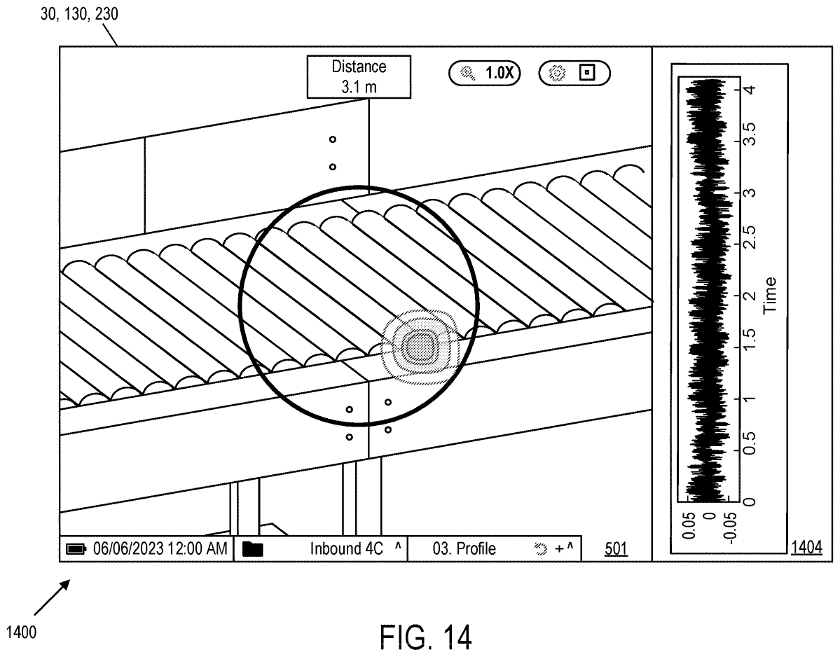

In the example shown, a graphical manipulation may be applied at the frequency selection region 504 to adjust a scaling of the frequency as displayed. For example, as illustrated a “pinch” action 1012 along the scaling axis may adjust the overall scale of frequencies displayed (e.g., either to cause display of a narrower or wider range of frequencies). In response thereto, a revised version of the frequency selection region 504 may be displayed. Such a rescaling operation may be possible in other graphical regions, including time-domain and other frequency-domain graphical displays such as those described below in connection with FIGS. 14-18.

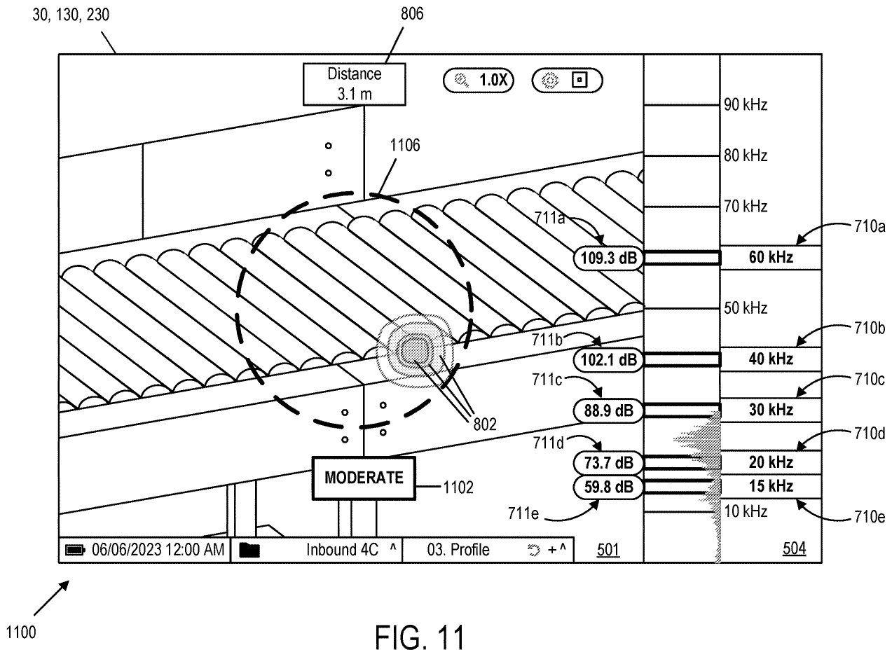

FIG. 11 illustrates a further example of an acoustic imaging user interface 1100. In this example, the acoustic imaging a user interface 1100 may be presented in response to selection of the mixed multi-mode option illustrated in FIG. 7. However, the acoustic imaging user interface 1100 includes additional, different notifications to the user to provide further insight regarding potential issues associated with the mechanical device emitting and acoustic signal that is the subject of analysis using an acoustic imaging system.

In particular, in the example as shown, the user interface is analogous to that seen in FIG. 8, including a plurality of predefined, selectable frequency indicators 710a-e, with associated acoustic signal level indicators 711a-e. In this example, however, there may be additional indicators identifying potential degradation of the mechanical system under tests. For example, a text box 1102 may include a notification indicating a potential degradation level of the device. The degradation level may be based on some combination of current detected acoustic signal levels at the predefined frequencies, previous tests of acoustic signal levels of the same component (and changes over time comparing the previous tests to the current detected acoustic signal levels), and known signal response of failing equipment. The known signal level response of a failing component may be based on determinations from other mechanical components of failure modes. Such failure predictive modes may be based on, for example, high frequency response (e.g., at 60 kHz) indicating failures of other mechanical equipment that is similarly situated.

In the example shown, the text box 1102 presents a text message indicative of a “moderate” likelihood of component failure based on detected acoustic signal levels. This may be based on the current, past, or changed signal levels being within predefined threshold values. Other levels indicating different likelihoods of component failure (no risk, low risk, moderate, high, extreme) may be based on use of other current and/or past acoustic signal response.

Additionally, in the example shown, the focus indicator 1106 may be configured to have a different appearance depending on the likelihood of component failure of a mechanical component positioned within the focus indicator 1106 within the field of view. In FIG. 11, this is depicted using a dashed line. However, in example implementations, the focus indicator may be a color-coded graphical element, with color-coded according to failure risk or imminence (e.g., green, yellow, orange, red reflecting increasing risk of component failure). Again, the basis for the changes or selection of colors of the focus indicator 1106 may be based on current or past signal levels as compared to thresholds or known failure modes (e.g. the appearance of high frequency signals within the frequency response).

In example implementations, one or both of the text box 1102 or the focus indicator 1106 may be included within a given user interface. Both the text box 1102 and the focus indicator 1106 are depicted in the user interface 1100 for purposes of simplicity; however, in some instances only one of the two types of signal classification notifications may be included. As described herein, the text box 1102 and the focus indicator 1106 may be referred to as severity indicators, given their usage.

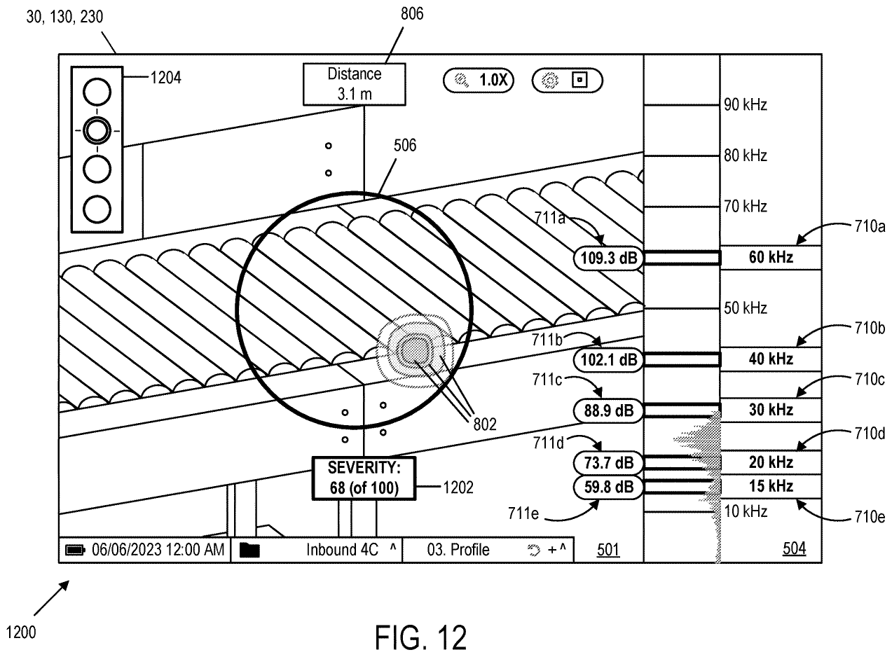

FIG. 12 illustrates a further example of an acoustic imaging user interface 1200 displaying a plurality of other optional severity indicators within the field of view region 501. The acoustic imaging user interface 1200 generally corresponds to the user interface 1100, but includes a severity score indicator 1202 and severity iconography 1204.

In the example shown, the severity score indicator 1202 presents a numerical score on a scale indicating severity of a known maintenance or failure issue detected on the basis of the acoustic response. In the example shown, the severity score corresponds to an estimated issue severity, and is normalized on a scale of 0 to 100; other scales may be used as well (e.g. 0 to 10, percentage basis, and the like). The severity score may be calculated or estimated based on acoustic signal level comparisons to thresholds or to past scores of known failure modes as described previously.

In the example shown, the severity iconography 1204 is depicted as a traffic signal indicator having a plurality of different light indicators that may be selectively eliminated to indicate a severity of issue detected. For example, a white light may indicate no risk, greenlight may indicate low risk, yellow light may indicate moderate risk, and red light may indicate high risk. In the example as illustrated, a severity score of 68 out of 100 within the severity score indicator 1202 corresponds to a moderate risk or yellow light being eliminated in the traffic signal indicator used as severity iconography 1204. Other correlations between severity score and color may be defined as well.

As with the severity indicators illustrated in FIG. 11, although both the severity score indicator 1202 and the severity iconography 1204 are depicted in the same user interface 1200, it is recognized that only one of these indicators may be used in a given user interface. Additionally, combinations of the severity indicators illustrated in FIGS. 11-12 may be used in conjunction with each other.

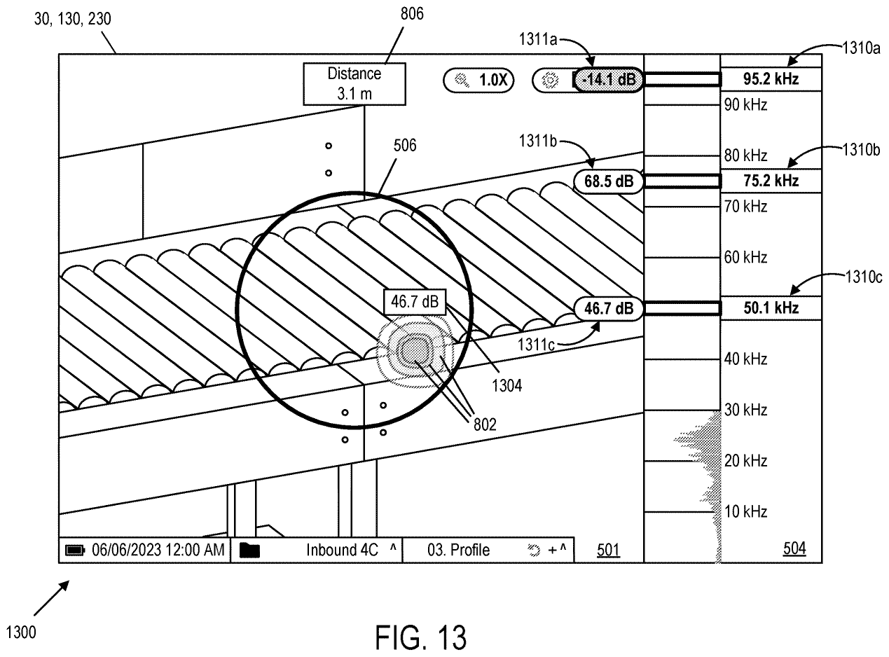

FIG. 13 illustrates a further example of an acoustic imaging user interface 1300. In this example, the acoustic imaging user interface 1300 displays a plurality of selected frequency indicators 1310a-c with associated acoustic signal level indicators 1311a-c. In this example, the frequency indicators 1310a-c may be individually manipulated, such that they are movable along the frequency range depicted within the frequency selection region 504.

In this example, individual ones of the acoustic signal level indicators 1311 may be color-coded or otherwise have a changed appearance based on a current detected acoustic signal level at the corresponding frequency being outside of a predetermined threshold. For example, in the user interface 1300 as shown, an acoustic response at 95.2 kHz selected using frequency indicator 1310a results in a negative decibel level, resulting in an alert indicator being presented within the corresponding acoustic signal level indicator 1311a. For example, indicator 1311a may have an alert appearance, e.g., a changed color of either the background of the indicator or the text itself (e.g., red, orange, yellow, or the like), may flash, or be depicted in a more visible manner (bold, larger size, and the like). Other acoustic signal level indicators 1311b-c may have a normal appearance (e.g., not differentiated from each other in size, color, or the like). Text box 1304 may depict overall acoustic signal levels, or may depict a selected one of the individual acoustic signal levels of the selected frequencies if particular attention should be paid to that frequency.

Referring generally to the user interfaces of FIGS. 8-13, it is noted that the acoustic signal strength readings as presented in the user interface are, in some embodiments, acoustic signal strength at the source of the signal, rather than as captured at the acoustic imaging device. That is, acoustic signal strength will be calculated using a combination of detected acoustic signal strength and the distance between the acoustic imaging device and the object being analyzed. As noted previously, the distance may be manually entered or may be automatically detected.

Use of acoustic signal strength at the source of the signal allows for improved comparison between current and prior measurements of acoustic signals emitted by the same object. Because a user of an acoustic imaging device may position the device at a slightly different location each time a test is performed, and because acoustic signal strength has an inverse square relationship to distance, use of the acoustic signal strength at the source improves reliability of comparison to past measurements, as well as comparison to known thresholds. As such, the severity of issues identified by severity indicators in the user interfaces described previously, as well as the alerts associated with individual frequencies may be presented with improved reliability.

It is noted that, because obtaining signal strength at the source of the signal requires a calculation based on received signal strength, both the signal strength at the source and the received signal strength may be captured. Additionally, the user interfaces as presented herein may be configured to allow a user to toggle between signal strength at the source and as received, for example within the acoustic settings menu sub screen 702 or another screen generated in response to selection of an option from the operation selection menu 502.

Referring now to FIGS. 14-18, additional user interface features are presented which allow for flexible analysis of received acoustic signals, for example by presenting various additional window regions alongside the field of view region 501 as presented in FIGS. 5-13. In particular, in addition to, or as a selectable replacement for, the frequency selection region 504 which presents a linear range of frequencies at which acoustic signals are assessed, FIGS. 14-18 illustrate other methods for analysis.

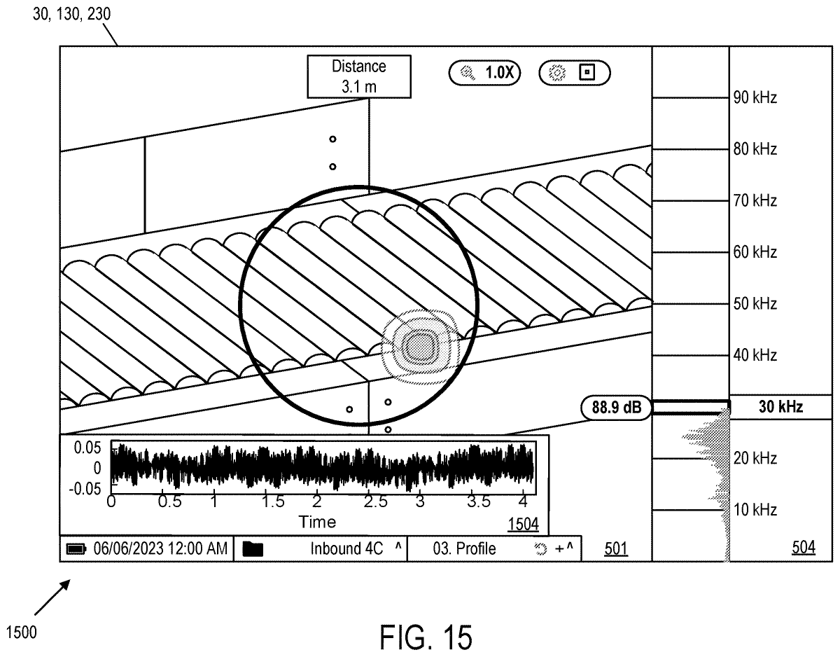

In a first particular example, in FIG. 14, an acoustic imaging user interface 1400 is depicted, including a time-domain acoustic signal graph 1404 displayable alongside a field of view region 501. In FIG. 15, a similar acoustic imaging user interface 1500 is depicted in which an analogous time-domain acoustic signal graph 1504 is positioned alongside the field of view region 501, but in addition to (rather than replacement of) the frequency selection region 504. The time-domain acoustic signal graphs 1404, 1504 may be useful to a user wanting to see general amplitude and time scale of detected acoustic signals. Such a graph may be manipulable by a user to scale the time domain within a range of available data to view overall signal response or response within a particular time window.

While the inclusion of such additional graph regions, such as time-domain acoustic signal graphs 1404, 1504 is contemplated by the present disclosure, the specific position and location of such graphs is intended as example only. Such graphs may be positioned in other positions and/or orientations relative to a field of view region, or in some instances may be presented as stand-alone graphs for analysis without display of such a field of view region.

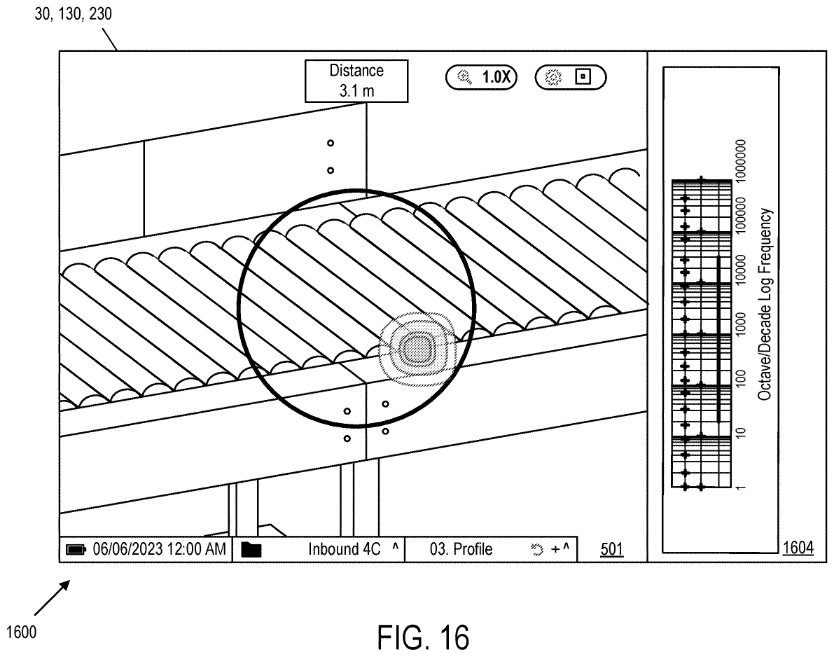

FIGS. 16-18 illustrate further examples of charts that are displayable alongside a field of view region 501, and optionally further alongside frequency selection region 504 (although not depicted here for simplicity). FIG. 16 illustrates an acoustic imaging user interface 1600 according to a still further example. The acoustic imaging user interface 1600 includes an octave/decade log frequency chart 1604 alongside the field of view region 501. The octave/decade log frequency chart may be used to identify signals that repeat in periodicity which are otherwise difficult to see within the available frequency range of the frequency selection region 504. In this example, the octave/decade log frequency chart 1604 uses a logarithmic scale and may present acoustic signals at particular frequencies to allow a user to see that periodicity.

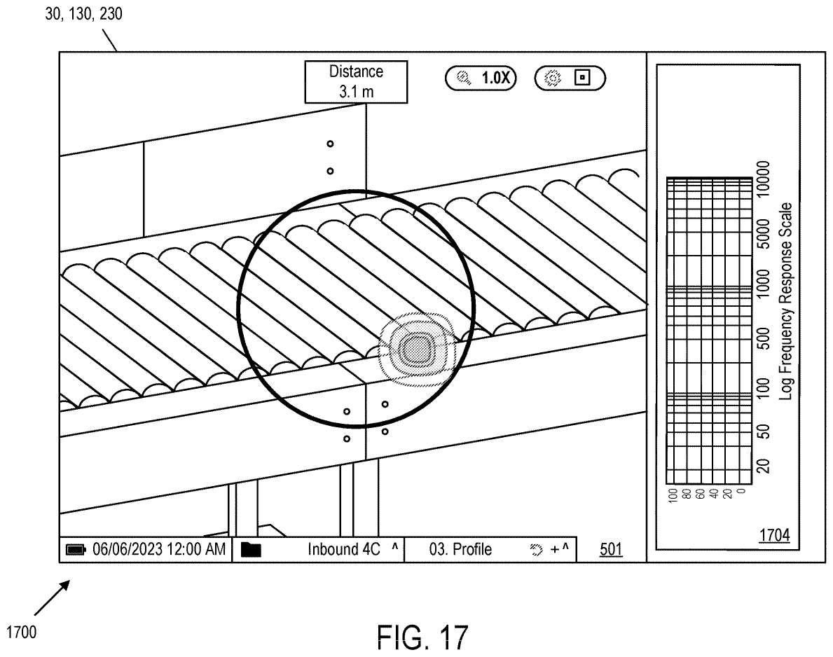

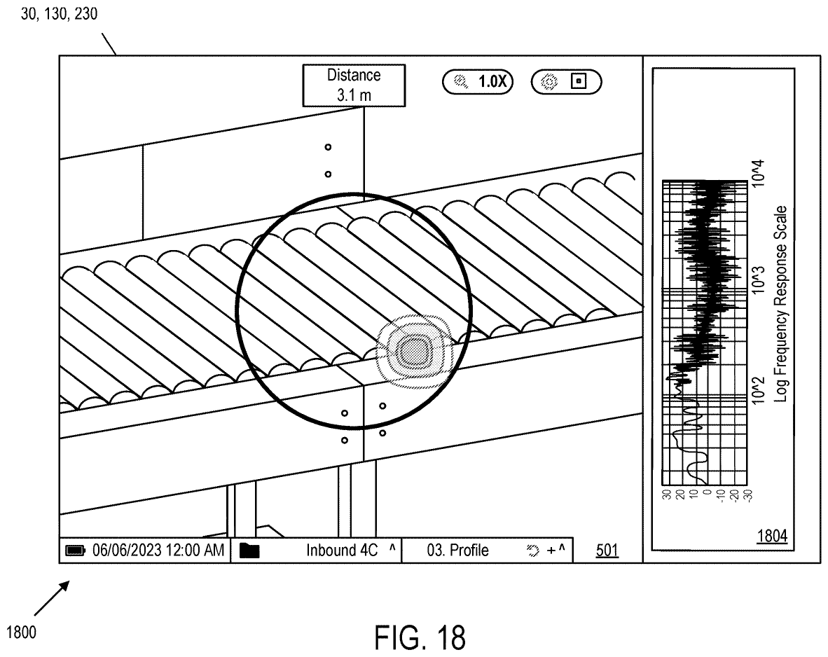

Similarly, FIG. 17 illustrates an acoustic imaging user interface 1700 including a log frequency response scale 1704 displayable in conjunction with a field of view region 501. The log frequency response scale 1704 allows display of both a wide frequency range of signals and a view of amplitude or signal strength of such signals concurrently, allowing the user to better see a wide range of signal response as compared to the frequency selection region 504. FIG. 18 illustrates an acoustic imaging user interface 1800 including a further version of a log frequency response scale 1804 displayable in conjunction with a field of view region 501. In this example, the log frequency response scale illustrates a generalized frequency response as captured, and has a scale of 30 to −30 dB over an entire frequency range (log scaled).

Referring to FIGS. 16-18, it is noted that the charts depicted in these user interfaces may be included in different orientations as well, and may be included alongside not only the field of view region, but also the frequency selection region as previously described. Additionally, and referring to FIGS. 14-18 generally, as noted above, the acoustic signal levels that are detected may be selectably set to be signal levels at a source of the acoustic signals, or as received at an acoustic imaging device. Further, the graphical elements as depicted are intended as exemplary rather than limiting, and reflect ways in which a user may more easily navigate among the wide range of frequencies that are possible to identify acoustic response signals of interest. Such user interfaces have particular applicability within the context of acoustic output of mechanical systems, but are applicable in a variety of other contexts as well, in a manner consistent with the present disclosure.

### III. Acoustic Imaging Systems and Interfaces—Methods of Use and Operation

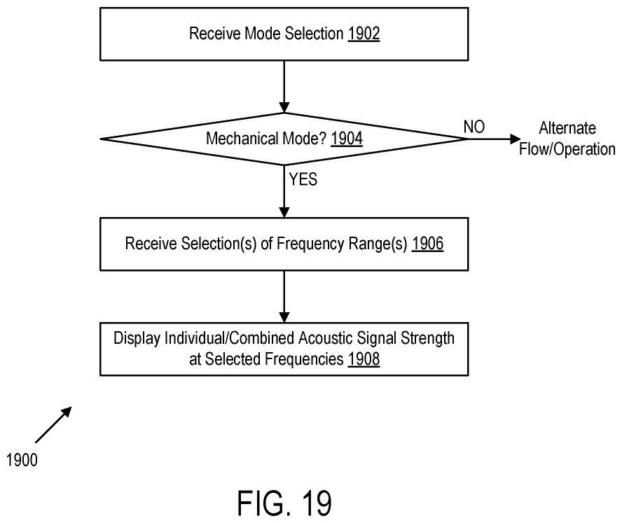

Referring now to FIGS. 19-22, methods of use and operation of acoustic imaging systems and the user interfaces that may be generated and interacted with are described. The methods of FIGS. 19-22 may be performed, for example, using an acoustic imaging device, a system that includes such an acoustic imaging device, or a computing device included within such a system. Examples of such devices and systems are provided above in connection with FIGS. 1-4.

In a particular example, FIG. 19 illustrates a flowchart of a method 1900 of performing acoustic imaging on a mechanical system, in accordance with example aspects of the present disclosure. The method 1900 includes receiving a mode selection in a user interface of an acoustic imaging system (step 1902). The mode selection may define a mechanical device acoustic response capture mode (e.g., receiving selection of a “MecQ” mode as noted above). Other modes, such as image capture mode, video capture mode, leak capture mode, pulse capture (“PDQ”) mode, and the like, are available as well, and may be selected in accordance with the present disclosure.

In the example shown, a determination of the mode selected is performed (at operation 1904). If a mechanical device acoustic response capture mode is selected, operation proceeds within the method as described below; if another mode is selected, optionally, other flows are followed by the acoustic imaging system (omitted here for brevity). It is noted that other modes may use similar user interfaces and/or flows.

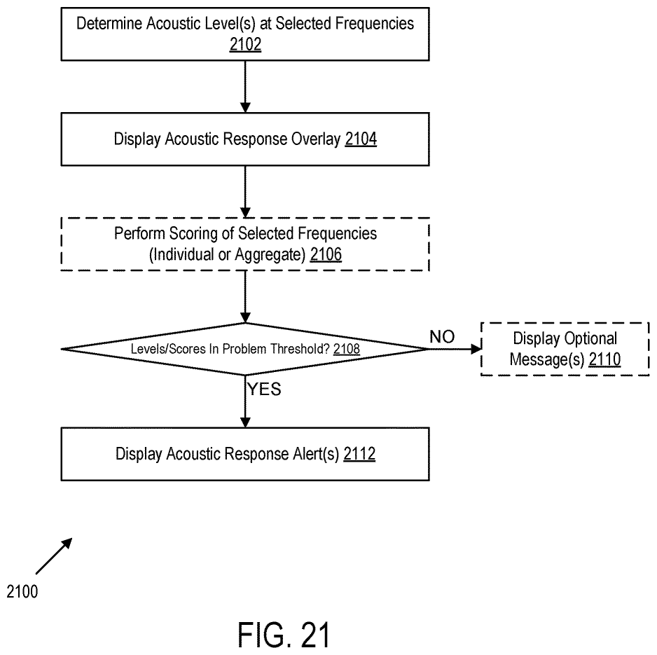

If, for example, the mechanical device acoustic response capture mode is selected, a selection of one or more frequencies or frequency ranges may be received (step 1906). The selection of one or more frequencies may include selection of a mixed multi-mode option in which a plurality of predefined frequencies is enabled. The plurality of predefined frequencies may be discontinuous with each other, displayed concurrently, and a set may be selected concurrently for analysis and display of acoustic signal strength. The selection of one or more frequencies may also include selection of another mode which allows a user to manually define one or more frequencies, and or adjust such frequencies by moving frequency indicators along a frequency scale within the user interface is described herein. The method also includes, in response to selection of the one or more frequencies or frequency ranges, display of the acoustic signal intensity at the selected frequencies (step 1908). Display of the acoustic signal intensity at the selected frequencies may include display of an overlay that reflects overall to stick signal strength for the selected frequencies. Display of the acoustic signal strength may also include display of individual acoustic signal strength at the selected frequencies. Optionally, display of the acoustic signal strength at the selected frequencies may include an adjustment of a user interface that displays those frequencies based on analysis of the detected signal strength relative to known issues that may arise at particular frequencies and signal strengths, for example to generate alerts and/or severity indicators that may act as guidance for users (as illustrated in FIGS. 11-13, below). An example of a method of generating such a display is described below in connection with FIG. 21.

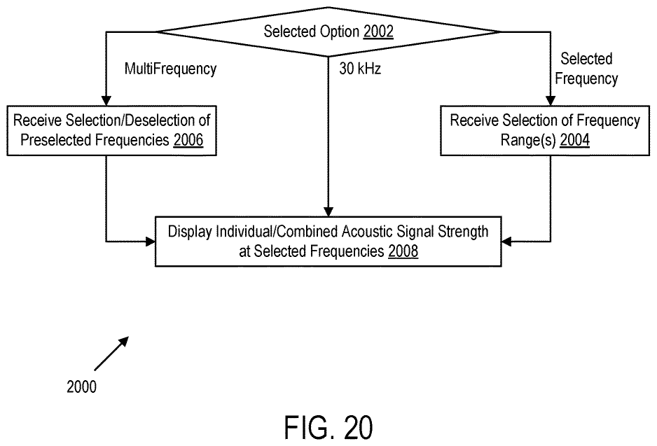

FIG. 20 is a flowchart illustrating a method 2000 of performing acoustic imaging on a mechanical system according to a selected mode of operation, in accordance with example aspects of the present disclosure. The method 2000 may be performed, for example, based on selection of the mechanical device acoustic response capture mode in steps 1902-1904, above, and presentation of options for selection of frequencies as illustrated in FIG. 7.

In the example shown, the method 2000 includes determining, at operation 2002 which option for frequency displayed is selected by a user at a user interface (e.g., the user interface of FIG. 7). The selected options may include a mixed multi-mode option, a fixed frequency option, and a user adjustable, selected frequency option. If the user adjustable, selected frequency option is selected, the method 2000 includes receiving a further selection of one or more frequencies or frequency ranges (step 2004). The one or more frequencies or frequency ranges may be displayed concurrently on a frequency scale depicted in a frequency selection region, and may be discontinuous with each other. The one or more frequencies may be adjustable, for example by user touch or a touch and drag option on a touchscreen display of a computing device, such as a remote system 10 or acoustic imaging device 102.

If the mixed multi-mode option is selected, the method includes receiving selection or de-selection of one or more preselected frequencies (step 2006). In examples, a plurality of discrete frequencies or narrow frequency bands are presented, and a user may select (e.g. by touch on a frequency indicator) each of the frequency bands to enable or disable those bands for inclusion within acoustic signal strength analysis.

In all modes of operation, operation will proceed to display the selected individual or combined acoustic signal strength at the frequencies selected by the user (step 2008). Such a display may be presented within a field of view region, and may overlay acoustic signal strength over an image of a field view that is captured by an acoustic imaging device. The display may include additional indicators, such as a distance between an acoustic imaging system and a target object, predicted or determined severity of degradation or likelihood of failure of a target object in a severity indicator or alarm, and the like. The display may include any of a variety of subsidiary analysis displays, such as those illustrated in FIGS. 14-18.

Referring now to FIG. 21, a flowchart of a method 2100 of generating a user interface for display at a computing system is provided. The method 2100 may be performed in accordance with performing acoustic imaging on a target object, such as a mechanical system. The user interface may be displayed on a display such as displays 30, 130, 230 as described above, as part of an acoustic imaging system 100 including an acoustic imaging device 102 and/or remote system 10.

In the example shown, the method 2100 includes determining acoustic levels at the frequencies selected by a user within the user interface (step 2102). The manner of selection of such frequencies depends on the mode of operation of the acoustic imaging system as previously described. The method 2100 also includes displaying an acoustic response overlay (step 2104). The acoustic response overlay may include a graphical illustration of acoustic signal strength overlaid over an image captured by an acoustic imaging device as illustrated in FIGS. 5-18.

In the example shown, the method 2100 includes, optionally, performing a scoring of one or more, and in some instances all, of acoustic signal strength at the selected frequencies (step 2106). The scoring of acoustic signal strength at the selected frequencies may take a variety of forms. In one example, scoring may include determining an overall signal strength, and comparing the overall signal strength to predefined thresholds to determine likelihood of degradation or failure of the target object (e.g., a mechanical component) within the field of view of the acoustic imaging device. The comparison relative to a threshold may result in a numerical score, or may result in a determination of a predefined level of severity which may be depicted in text, graphically (e.g. in color and/or iconography), and the like. The comparison may be performed on aggregate signals, or on individual acoustic signal strengths at discrete frequencies. The determination of how severity may be assessed may vary by implementation, and may be based on historical failure modes and related known signal response.

In the example shown, the method 2100 includes comparison of the one or more levels or scores determined by way of the analysis to a threshold (at operation 2108). If there are no frequencies or scores indicating a problem (e.g. within a threshold of problematic operation), optionally one or more display messages may be presented indicating appropriate operation of the target object (step 2110). If, however, one or more frequencies or scores, or an aggregate of the signal strengths across selected frequencies is indicative of potential failure, a display may be generated indicating one or more alerts associated with either the problematic acoustic signal, frequency, or within the field of view associated with the object and overlay displayed thereon (step 2112).

As noted previously, where historical signal levels are used, or changes in signal level over time are used to determine the potential failure or degradation of a target object, in some examples signal strengths at the target object are used, compared to signal strengths as received. This comparison allows for improved reliability of indications that may be generated and displayed via the user interfaces described herein.

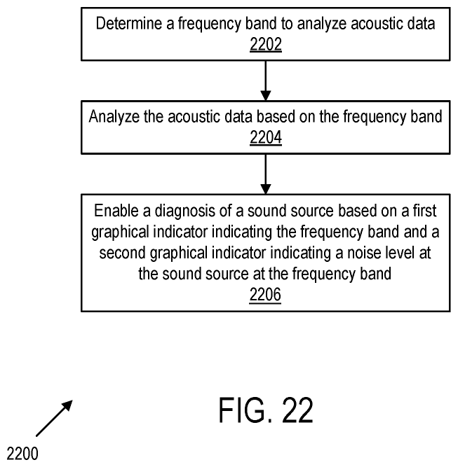

Referring now to FIG. 22, a flowchart of a method 2200 for acoustic data analysis and diagnosis is described. This method includes analysis of acoustic data and diagnosis of a sound source according to the various examples described above. As indicated in FIG. 22, the method 2200 includes a step 2202 in which a frequency band is determined in order to analyze acoustic data obtained from acoustic signals received from an area or scene.

As a step 2204, the acoustic data is analyzed based on the frequency band, as described herein. This analysis enables a diagnosis of the sound source at step 2206. Such diagnosis, in this example, is performed based on a first graphical indicator shown in the user interface indicating the frequency band, and a second graphical indicator shown in the user interface indicating a noise level at the sound source at (or within) the frequency band, in accordance with example aspects of this disclosure.

In this disclosure, an exemplary computing device may include a display screen; a processor; or a memory storing instructions executable by the processor, wherein the instructions, when executed, cause the computing device to: display, on the display screen, a user interface including a field of view region and a frequency selection region, the frequency selection region may display a frequency scale and including a plurality of selectable frequency indicators concurrently displayable thereon, the plurality of selectable frequency indicators may include at least a first selectable frequency indicator or a second selectable frequency indicator, the first and second selectable frequency indicators being selectable independently of one another and indicating different frequencies on the frequency scale. Further, the field of view region may display an image of a field of view including an overlay of a detected acoustic signal strength, the overlay of the detected acoustic signal strength being based, at least in part, on selected ones of the plurality of selectable frequency indicators identified in the frequency selection region.

The plurality of selectable frequency indicators may be associated with a plurality of predefined frequencies, wherein each of the predefined frequencies may be selectable via the display to be enabled or disabled within the frequency selection region. The overlay of the detected acoustic signal strength may be based on a subset of the plurality of predefined frequencies that are enabled within the frequency selection region. The plurality of selectable frequency indicators may be each associated with a frequency sub-range on the frequency scale and are adjustable within a range of frequencies depicted on the frequency scale. The computing device may include an acoustic imaging device, and the acoustic imaging device may include an acoustic sensor array and a camera system. The computing device may be communicatively connected to a second computing device, the second computing device may include an acoustic imaging device including an acoustic sensor array and a communication interface. The field of view region may include a focus indicator, wherein the overlay is positioned, at least in part, within the focus indicator.

The user interface may include a severity indicator, the severity indicator being based, at least in part, on the detected acoustic signal. The severity indicator may include at least one of a severity score indicating an estimated issue severity associated with the detected acoustic signal; a color-coded graphical element having an appearance based on the estimated issue severity associated with the detected acoustic signal; or a text message displayed in proximity to the overlay that indicates a level of the estimated issue severity associated with the detected acoustic signal. The color-coded graphical element may include at least one of a focus indicator, a traffic signal indicator, or an acoustic reading display associated with one or more of the selected ones of the plurality of selectable frequency indicators.

The user interface may further include at least one of a time-domain acoustic signal graph or a log frequency response scale. Each of the first selectable frequency indicator and the second selectable frequency indicator may be associated with a continuous range of frequencies and is user-adjustable via the user interface. The first range of frequencies associated with the first selectable frequency indicator may be discontinuous with a second range of frequencies associated with the second selectable frequency indicator. The user interface may further include a menu bar including an acoustic imaging option, and wherein the acoustic imaging option, when selected, may cause display of a plurality of capture modes including a mechanical device acoustic imaging mode.

An exemplary acoustic imaging device may include an acoustic sensor array; a camera system; a touch-screen display; a processing system communicatively connected to the acoustic sensor array, the camera system, and the touch-screen display; or a memory communicatively connected to the processing system. The memory storing instructions which, when executed by the processing system, may cause the processing system to: generate a graphical user interface displayable on the touch-screen display. The graphical user interface may include a frequency selection region displaying a frequency scale and including a plurality of selectable frequency indicators concurrently displayable thereon, the plurality of selectable frequency indicators including at least a first selectable frequency indicator and a second selectable frequency indicator, the first and second selectable frequency indicators being selectable independently of one another and indicating different frequencies on the frequency scale; or a field of view region displaying an image of a field of view of the camera system including an overlay of a detected acoustic signal strength obtained from the acoustic sensor array, the overlay of the detected acoustic signal strength being based, at least in part, on selected ones of the plurality of selectable frequency indicators identified in the frequency selection region. The plurality of selectable frequency indicators may be associated with a plurality of predefined frequencies, wherein each of the predefined frequencies may become selectable via the touchscreen display to be enabled or disabled within the frequency selection region. During an acoustic sampling process, an acoustic signal level indicator may be displayed within the user interface for each of the enabled ones of the plurality of selectable frequency indicators. The acoustic signal level indicator may be displayed in one of an alert appearance or a normal appearance, the alert appearance being based on whether an acoustic signal that is at a frequency associated with the selected frequency indicator and is emitted by a mechanical component and detected via the acoustic sensor array is indicative of possible failure of the mechanical component. The user interface may include a severity indicator displayable within the field of view region, the severity indicator being based, at least in part, on the detected acoustic signal. The severity indicator may include at least one of: a severity score indicating an estimated issue severity associated with the detected acoustic signal; a color-coded graphical element having an appearance based on the estimated issue severity associated with the detected acoustic signal; or a text message displayed in proximity to the overlay that indicates a level of the estimated issue severity associated with the detected acoustic signal.

An exemplary method of performing acoustic imaging on a mechanical system, the method may include one or more steps, such as receiving a selection of a mechanical device acoustic imaging mode at a display screen associated with an acoustic imaging device; receiving a selection of an option from among a plurality of options displayed on the display screen in response to selection of the mechanical device acoustic imaging mode, the option being selected from among a single frequency option, a multifrequency option, and a customizable frequency option; in response to receiving selection of the multifrequency option, displaying a user interface on the display screen, the user interface including a frequency selection region and a field of view region, wherein: the frequency selection region displays a frequency scale and including a plurality of selectable frequency indicators concurrently displayable thereon, the plurality of selectable frequency indicators including a plurality of predefined frequencies, each of the predefined frequencies being selectable via the display to be enabled or disabled within the frequency selection region, and the field of view region displaying an image of a field of view represented in image data including an overlay of a detected acoustic signal strength obtained from an acoustic sensor data; and receiving selection of one or more of the plurality of selectable frequency indicators to cause a subset of the predefined frequencies to be enabled, wherein the overlay of the detected acoustic signal strength is based, at least in part, on the enabled ones of the plurality of selectable frequency indicators.

Referring generally to FIGS. 1-22, functionality of computing devices described herein may be implemented in computing logic embodied in hardware or software instructions, which can be written in a programming language, such as C, C++, COBOL, JAVA™, PHP, Perl, HTML, CSS, Javascript, PythonScript, VBScript, ASPX, Microsoft . NET™ languages such as C#, or the like. Computing logic may be compiled into executable programs or written in interpreted programming languages. Generally, functionality described herein can be implemented as logic modules that can be duplicated to provide greater processing capability, merged with other modules, or divided into sub-modules. The computing logic can be stored in any type of computer-readable medium (e.g., a non-transitory medium such as a memory or storage medium) or computer storage device and be stored on and executed by one or more general-purpose or special-purpose processors, thus creating a special-purpose computing device configured to provide functionality described herein.

Many alternatives to the systems and devices described herein are possible. For example, individual modules or subsystems can be separated into additional modules or subsystems or combined into fewer modules or subsystems. As another example, modules or subsystems can be omitted or supplemented with other modules or subsystems. As another example, functions that are indicated as being performed by a particular device, module, or subsystem may instead be performed by one or more other devices, modules, or subsystems. Although some examples in the present disclosure include descriptions of devices comprising specific hardware components in specific arrangements, techniques and tools described herein can be modified to accommodate different hardware components, combinations, or arrangements. Further, although some examples in the present disclosure include descriptions of specific usage scenarios, techniques and tools described herein can be modified to accommodate different usage scenarios. Functionality that is described as being implemented in software can instead be implemented in hardware, or vice versa.

Many alternatives to the techniques described herein are possible. For example, processing stages in the various techniques can be separated into additional stages or combined into fewer stages. As another example, processing stages in the various techniques can be omitted or supplemented with other techniques or processing stages. As another example, processing stages that are described as occurring in a particular order can instead occur in a different order. As another example, processing stages that are described as being performed in a series of steps may instead be handled in a parallel fashion, with multiple modules or software processes concurrently handling one or more of the illustrated processing stages. As another example, processing stages that are indicated as being performed by a particular device or module may instead be performed by one or more other devices or modules.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the claimed subject matter.

This application claims the benefit of and priority to U.S. Provisional Application No. 63/506,563, filed Jun. 6, 2023, and U.S. Provisional Application No. 63/607,938, filed Dec. 8, 2023, which applications are hereby incorporated by reference in their entireties.

1. A method for enabling acoustic diagnosis, comprising:
in response to an acoustic device entering into an operation mode, causing a plurality of selectable graphical indicators corresponding to respective ones of a plurality of frequency bands to be presented with a frequency scale on a graphical user interface;
determining a noise level at a sound source at a frequency band of the plurality of frequency bands; and
enabling a visual diagnosis of the sound source based on a first type of graphical indicator indicating the frequency band and a second type of graphical indicator indicating the noise level at the sound source at the frequency band being concurrently presented along the frequency scale.

2. The method of claim 1, further comprising:
locking the plurality of frequency bands presented with the frequency scale on the graphical user interface.

3. The method of claim 1, further comprising:
fixing spatial configurations of the plurality of frequency bands relative to the frequency scale on the graphical user interface.

4. The method of claim 1, further comprising:
floating the plurality of frequency bands presented with the frequency scale to become adjustable within a range of frequencies depicted on the frequency scale.

5. The method of claim 1, further comprising:
enabling the visual diagnosis of the sound source further based on a plurality of second type of graphical indicators indicating respective noise levels at respective frequency bands of the plurality of frequency bands at the sound source.

6. The method of claim 1, further comprising:
receiving, via the graphical user interface, a user input associated with one of the plurality of selectable graphical indicators to select or deselect the frequency band of the plurality of frequency bands.

7. The method of claim 6, further comprising:
in response to the user input, causing a visual appearance change of the one of the plurality of selectable graphical indicators.

8. The method of claim 6, further comprising:
in response to the user input, causing an appearance or disappearance of the second type of graphical indicator indicating the noise level at the frequency band at the sound source.

9. The method of claim 1, further comprising:
in response to a user selection of the operation mode, selecting the plurality of frequency bands to analyze acoustic data under the operation mode.

10. The method of claim 1, further comprising:
enabling the visual diagnosis of the sound source further based on saving a first information of the frequency band and a second information of the noise level at the frequency band as metadata of an acoustic image related to the sound source.

11. The method of claim 10, further comprising:
enabling the visual diagnosis of the sound source further based on retrieving the first information of the frequency band and the second information of the noise level at the frequency band from the metadata of the acoustic image, and analyzing the first information of the frequency band and the second information of the noise level at the frequency band in view of other acoustic images related to the sound source.

12. The method of claim 1, further comprising:
enabling the visual diagnosis of the sound source further based on a severity indicator associated with the sound source, the severity indicator being presented on the graphical user interface together with the second type of graphical indicator indicating the noise level at the frequency band at the sound source.

13. The method of claim 12, wherein the severity indicator comprises at least one of:
a severity score indicating an estimated issue severity associated with the sound source;
a color-coded graphical element having an appearance based on the estimated issue severity associated with the sound source; or
a text message indicating a level of the estimated issue severity associated with the sound source.

14. An acoustic device, comprising:
a processor; and
a memory storing instructions executable by the processor, wherein the instructions, when executed, cause the processor to:
determine a frequency band to analyze acoustic data under an operation mode of the acoustic device;
analyze the acoustic data based on the frequency band; and
enable a diagnosis of a sound source based on a first graphical indicator of a first type indicating the frequency band and a second graphical indicator of a second type indicating a noise level at the sound source at the frequency band being concurrently presented along a frequency scale.

15. The acoustic device of claim 14, wherein the instructions, when executed, further cause the processor to:
keep the second graphical indicator indicating the noise level at the sound source at the frequency band substantially stable in response to a change in a distance between the acoustic device and the sound source.

16. The acoustic device of claim 14, wherein the instructions, when executed, further cause the processor to:
generate a third type of graphical indicator representing the sound source and cause the third type of graphical indicator to be overlayed on an image showing a field of view of the acoustic device.

17. The acoustic device of claim 16, wherein the instructions, when executed, further cause the processor to:
update the third type of graphical indicator representing the sound source in response to a change in a distance between the acoustic device and the sound source, wherein the third type of graphical indicator includes a component representing a noise level at acoustic sensors of the acoustic device.

18. The acoustic device of claim 14, further comprising:
an acoustic imaging device including an acoustic sensor array and a camera system.

19. The acoustic device of claim 14, wherein the acoustic device is communicatively connected to a second computing device, the second computing device comprising an acoustic imaging device including an acoustic sensor array and a communication interface.

20. The acoustic device of claim 14, further comprising:
a display to present the first graphical indicator indicating the frequency band and the second graphical indicator indicating the noise level at the sound source at the frequency band.
